(19) United States
(12) Patent Application Publication
(10) Pub. No.: US 2023/0295191 A1
(43) Pub. Date: Sep. 21, 2023

(54) A POLYESTER MOLDING COMPRISING A METAL-ORGANIC FRAMEWORK HAVING A LOW OUTGASSING OF VOLATILE ORGANIC COMPOUNDS

(71) Applicant: BASF SE, Ludwigshafen (DE)

(72) Inventors: Erik Gubbels, Ludwigshafen (DE); Maximilian Lehenmeier, Ludwigshafen (DE); Alvaro Gordillo Bolonio, Barcelona (ES)

(21) Appl. No.: 18/018,709

(22) PCT Filed: Aug. 2, 2021
(86) PCT No.: PCT/EP2021/071567

§ 371 Date: Jan. 30, 2023

(30) Foreign Application Priority Data
Aug. 3, 2020 (EP) 20189084.5

(51) Int. Cl. C07F 5/06; C08L 67/02; C08K 5/56

(52) U.S. Cl. CPC C07F 5/069; C08L 67/02; C08K 5/56; C08L 2203/16

(57) ABSTRACT

The present invention relates to a molding comprising, (i) a polyester in an amount in the range of from 25 to 99.99 weight-%, based on the total weight of the molding, (ii) a metal-organic framework in an amount of from 0.01 to 25 weight-%, based on the total weight of the molding, wherein the metal-organic framework comprises one or more metal ions M and one or more organic ligands. Further, the present invention relates to a process for preparation of such a molding and use thereof.

### TECHNICAL FIELD

The present invention relates to a molding comprising, (i) a polyester in an amount in the range of from 25 to 99.99 weight-%, based on the total weight of the molding, and (ii) a metal-organic framework in an amount of from 0.01 to 25 weight-%, based on the total weight of the molding.

Further, the present invention relates to the preparation of said molding and use thereof in particular for applications which require low emissions of volatile organic compounds (VOC).

### INTRODUCTION

An inherent problem of polyesters is the outgassing of volatile organic compounds (VOC). For example, polyesters containing building units derived from 1,4-butanediol (e.g. poly(butylene terephthalate) (PBT)) can emit volatile organic compounds, wherein in particular tetrahydrofuran typically account for more than 95% of the total VOC. Other volatile organic compounds that may be emitted are for example butadiene, acetaldehyde, furan, acrolein, methanol, 1-butene-4-01, and derivatives of tetrahydrofuran. Tetrahydrofuran (THF) usually results from the so called “back-biting” reaction of the building units derived from 1,4-butanediol, in particular from said building units forming end-groups of a polyester. Depolymerization processes of this type take place in particular when polyesters are kept for long periods in the melt or are processed under extreme conditions, e. g. at a high temperature, under a high pressure, or the like.

The outgassing of volatile organic compounds, in particular of THF, limits the use of such polyesters since migration limits are set in particular in the European Union. More specifically, in food contact and medical applications the European Union has set a specific migration limit for THF. Moreover, in the transportation sector the THF levels are set by in-vehicle air quality standards and said levels are continuously lowered, usually every few years. Current polyester materials containing 1.4-butanediol building units show a comparatively high outgassing, whereby levels are reached which would often exceed a regulatory threshold.

EP 3004242 B1 relates to polyester molding compositions with a comparatively low total organic carbon (TOC) emission. In particular, a thermoplastic molding composition is disclosed which comprises a specific amount of a polyester composed of at least one polyalkylene terephthalate, a further polyester, an acrylic acid polymer composed of an acrylic acid and at least one other ethylenically unsaturated monomer.

JP 2019 014826 A relates to a composite comprising a resin and either a RHO-type zeolite, a molecular sieve 13X, an LTA-type zeolite, or a high silica zeolite. The resin may be a thermoplastic resin, and in particular comprise a polybutylene terephthalate resin. It is disclosed that said composite has a low linear thermal expansion coefficient.

WO 2019/189337 A1 relates to an odor adsorbent molded article resin composition comprising at least a thermoplastic resin A and an odor adsorbent, wherein the odor adsorbent comprises a hydrophobic zeolite having a SiO₂/Al₂O₃ molar ratio of 30/1 to 8000/1, wherein the melt flow rate of the thermoplastic resin A is in the range of from 5 to 100 g/min.

WO 2012/042410 A1 relates to a process for preparing a porous metal-organic framework based on aluminum and fumaric acid. Similarly, WO 2007/118841 A2 relates to a metal-organic framework based on aluminum and fumarate.

### DETAILED DESCRIPTION

It was therefore an object of the present invention to provide a novel molding which exhibits reduced emissions of volatile organic compounds, thus exhibiting in particular improved properties with respect to its emissions of total organic carbon. It was a particular subject of the present invention to provide a novel molding exhibiting reduced emissions of volatile organic compounds, and more particularly reduced emissions of tetrahydrofuran. Further, it was an object to provide a process for preparing such a novel molding.

Surprisingly, it has been found that a novel molding comprising a poly(butylene dicarboxylate) polyester and a specific metal-organic framework exhibits reduced emissions of total organic carbon, in particular of volatile organic compounds, and more particularly of tetrahydrofuran. It has been particularly found that a novel molding can be provided according to the present invention which shows particularly improved properties with respect to the emissions of volatile organic compounds, in particular of tetrahydrofuran, when tested according to VDA277 being especially designed for the determination of automotive volatile organic compounds.

Therefore, the present invention relates to a molding comprising,
(i) a polyester in an amount in the range of from 25 to 99.99 weight-%, based on the total weight of the molding,
(ii) a metal-organic framework in an amount of from 0.01 to 25 weight-%, based on the total weight of the molding,
   wherein the metal-organic framework comprises one or more metal ions M and one or more organic ligands.

It is preferred that the one or more metal ions M comprised in the metal-organic framework are selected from groups 2, 11, 12, 13 of the periodic system of elements, and combinations of two or more thereof, wherein the one or more metal ions M are more preferably selected from the group consisting of Al, Ga, Cu, Ag, Zn, Mg, Mn, Ti, Fe, and combinations of two or more thereof, wherein the one or more metal ions M more preferably are one or more of Al and Zn, wherein the one or more metal ions M more preferably are Al, wherein the one or more metal ions M preferably are positively charged.

It is preferred that the metal-organic framework comprised in the molding comprises the one or more metal ions M in an amount in the range of from 10 to 25 weight-%, more preferably in the range of from 15 to 20 weight-%, more preferably in the range of from 16.0 to 17.6 weight-%, more preferably in the range of from 16.2 to 17.2 weight-%, more preferably in the range of from 16.4 to 17.0 weight-%, based on the total weight of the metal-organic framework.

It is preferred that the one or more organic ligands comprised in the metal-organic framework are coordinated to the one or more metal ions M, more preferably as a bidentate ligand of the one or more metal ions M.

It is preferred that the one or more organic ligands comprised in the metal-organic framework are anions, more preferably one or more of monoanions, dianions, trianions, and tetraanions, more preferably one or more of dicarboxylates, tricarboxylates, and tetracarboxylates.

According to a first alternative, it is preferred that the one or more organic ligands comprised in the metal-organic framework comprise, preferably consist of, one or more of oxalate, succinate, tartrate, 1,4-butanedicarboxylate, 1,4-butenedicarboxylate, 4-oxopyran-2,6-dicarboxylate, 1,6-hexanedicarboxylate, decanedicarboxylate, 1,8-heptadecanedicarboxylate, 1,9-heptadecanedicarboxylate, heptadecanedicarboxylate, acetylenedicarboxylate, 1,2-benzenedicarboxylate, 1,3-benzenedicarboxylate, 2,3-pyridinedicarboxylate, pyridine-2,3-dicarboxylate, 1,3-butadiene-1,4-dicarboxylate, 1,4-benzenedicarboxylate, p-benzenedicarboxylate, imidazole-2,4-dicarboxylate, 2-methylquinoline-3,4-dicarboxylate, quinoline-2,4-dicarboxylate, quinoxaline-2,3-dicarboxylate, 6-chloroquinoxaline-2,3-dicarboxylate, 4,4′-diaminophenylmethane-3,3′-dicarboxylate, quinoline-3,4-dicarboxylate, 7-chloro-4-hydroxyquinoline-2,8-dicarboxylate, diimidedicarboxylate, pyridine-2,6-dicarboxylate, 2-methylimidazole-4,5-dicarboxylate, thiophene-3,4-dicarboxylate, 2-isopropylimidazole-4,5-dicarboxylate, tetrahydropyran-4,4-dicarboxylate, perylene-3,9-dicarboxylate, perylenedicarboxylate, Pluriol E 200-dicarboxylate, 3,6-dioxaoctanedicarboxylate, 3,5-cyclohexadiene-1,2-dicarboxylate, octanedicarboxylate, pentane-3,3-carboxylate, 4,4′-diamino-1,1′-biphenyl-3,3′-dicarboxylate, 4,4′-diaminobiphenyl-3,3′-dicarboxylate, benzidine-3,3′-dicarboxylate, 1,4-bis(phenylamino)benzene-2,5-dicarboxylate, 1,1′-binaphthyldicarboxylate, 7-chloro-8-methylquinoline-2,3-dicarboxylate, 1-anilinoanthraquinone-2,4′-dicarboxylate, polytetrahydrofuran 250-dicarboxylate, 1,4-bis(carboxymethyl)piperazine-2,3-dicarboxylate, 7-chloroquinoline-3,8-dicarboxylate, 1-(4-carboxy)phenyl-3-(4-chloro)phenylpyrazoline-4,5-dicarboxylate, 1,4,5,6,7,7-hexachloro-5-norbornene-2,3-dicarboxylate, phenylindanedicarboxylate, 1,3-dibenzyl-2-oxoimidazolidine-4,5-dicarboxylate, 1,4-cyclohexanedicarboxylate, naphthalene-1,8-dicarboxylate, 2-benzoylbenzene-1,3-dicarboxylate, 1,3-dibenzyl-2-oxoimidazolidine-4,5-cis-dicarboxylate, 2,2′-biquinoline-4,4′-dicarboxylate, pyridine-3,4-dicarboxylate, 3,6,9-trioxaundecanedicarboxylate, hydroxybenzophenonedicarboxylate, Pluriol E 300-dicarboxylate, Pluriol E 400-dicarboxylate, Pluriol E 600-dicarboxylate, pyrazole-3,4-dicarboxylate, 2,3-pyrazinedicarboxylate, 5,6-dimethyl-2,3-pyrazinedicarboxylate, bis(4-aminophenyl) ether diimide-dicarboxylate, 4,4′-diaminodiphenylmethane diimide-dicarboxylate, bis(4-aminophenyl) sulfone diimide-dicarboxylate, 1,4-naphthalenedicarboxylate, 2,6-naphthalene-dicarboxylate, 1,3-adamantanedicarboxylate, 1,8-naphthalenedicarboxylate, 2,3-naphthalenedicarboxylate, 8-methoxy-2,3-naphthalenedicarboxylate, 8-nitro-2,3-naphthalenecarboxylate, 8-sulfo-2,3-naphthalenedicarboxylate, anthracene-2,3-dicarboxylate, 2′,3′-diphenyl-p-terphenyl-4,4″-dicarboxylate, (diphenyl ether)-4,4′-dicarboxylate, imidazole-4,5-dicarboxylate, 4(1H)-oxothiochromene-2,8-dicarboxylate, 5-tert-butyl-1,3-benzenedicarboxylate, 7,8-quinolinedicarboxylate, 4,5-imidazoledicarboxylate, 4-cyclohexene-1,2-dicarboxylate, hexatriacontanedicarboxylate, tetradecanedicarboxylate, 1,7-heptanedicarboxylate, 5-hydroxy-1,3-benzenedicarboxylate, 2,5-dihydroxy-1,4-benzenedicarboxylate, pyrazine-2,3-dicarboxylate, furan-2,5-dicarboxylate, 1-nonene-6,9-dicarboxylate, eicosenedicarboxylate, 4,4′-dihydroxy-diphenylmethane-3,3′-dicarboxylate, 1-amino-4-methyl-9,10-dioxo-9,10-dihydroanthracene-2,3-dicarboxylate, 2,5-pyridinedicarboxylate, cyclohexene-2,3-dicarboxylate, 2,9-dichlorofluorubin-4,11-dicarboxylate, 7-chloro-3-methylquinoline-6,8-dicarboxylate, 2,4-dichlorobenzophenone-2′,5′-dicarboxylate, 1,3-benzenedicarboxylate, 2,6-pyridinedicarboxylate, 1-methylpyrrol-3,4-dicarboxylate, 1-benzyl-1H-pyrrol-3,4-dicarboxylate, anthraquinone-1,5-dicarboxylate, 3,5-pyrazoledicarboxylate, 2-nitrobenzene-1,4-dicarboxylate, heptane-1,7-dicarboxylate, cyclobutane-1,1-dicarboxylate, 1,14-tetradecanedicarboxylate, 5,6-dehydronorbornane-2,3-dicarboxylate, 5-ethyl-2,3-pyridinedicarboxylate, and camphordicarboxylate.

According to a second alternative, it is preferred that the one or more organic ligands comprised in the metal-organic framework comprise, preferably consist of, one or more of 2-Hydroxy-1,2,3-propanetricarboxylate, 7-chloro-2,3,8-quinolinetricarboxylate, 1,2,3-benzenetricarboxylate, 1,2,4-benzenetricarboxylate, 1,2,4-butanetricarboxylate, 2-phosphono-1,2,4-butanetricarboxylate, 1,3,5-benzenetricarboxylate, 1-hydroxy-1,2,3-propanetricarboxylate, 4,5-dihydroxy-4,5-dioxo-1H-pyrrolo[2,3-f]quinoline-2,7,9-tricarboxylate, 5-acetyl-3-amino-6-methylbenzene-1,2,4-tricarboxylate, 3-amino-5-benzoyl-6-methylbenzene-1,2,4-tricarboxylate, 1,2,3-propanetricarboxylate, and aurintricarboxylate.

According to a third alternative, it is preferred that the one or more organic ligands comprised in the metal-organic framework comprise, preferably consist of, one or more of 1,1-Dioxidoperylo[1,12-BCD]thiophene-3,4,9,10-tetracarboxylate, a perylenetetracarboxylate, preferably perylene-3,4,9,10-tetracarboxylate or (perylene-1,12-sulfone)-3,4,9,10-tetracarboxylate, a butanetetracarboxylate, preferably 1,2,3,4-butanetetracarboxylate or meso-1,2,3,4-butanetetracarboxylate, decane-2,4,6,8-tetracarboxylate, 1,4,7,10,13,16-hexaoxacyclooctadecane-2,3,11,12-tetracarboxylate, 1,2,4,5-benzenetetracarboxylate, 1,2,11,12-dodecanetetracarboxylate, 1,2,5,6-hexanetetracarboxylate, 1,2,7,8-octanetetracarboxylate, 1,4,5,8-naphthalenetetracarboxylate, 1,2,9,10-decanetetracarboxylate, benzophenonetetracarboxylate, 3,3′,4,4′-benzophenonetetracarboxylate, tetrahydrofurantetracarboxylate, and a cyclopentanetetracarboxylate, preferably cyclopentane-1,2,3,4-tetracarboxylate.

According to a fourth alternative, it is preferred that the one or more organic ligands comprised in the metal-organic framework comprise, preferably consist of, one or more of acetylenedicarboxylate (ADC), camphordicarboxylate, fumarate, succinate, a benzenedicarboxylate, an naphthalenedicarboxylate, a biphenyldicarboxylate, preferably 4,4′-biphenyldicarboxylate (BPDC), a pyrazinedicarboxylate, preferably 2,5-pyrazinedicarboxylate, a bipyridinedicarboxylate, preferably a 2,2′-bipyridinedicarboxylate, more preferably 2,2′-bipyridine-5,5′-dicarboxylate, a benzenetricarboxylate, more preferably one or more of 1,2,3-benzenetricarboxylate, 1,2,4-benzenetricarboxylate, and 1,3,5-benzenetricarboxylate (BTC), benzenetetracarboxylate, adamantanetetracarboxylate (ATC), adamantanedibenzoate (ADB), benzenetribenzoate (BTB), methanetetrabenzoate (MTB), adamantanetetrabenzoate, and a dihydroxyterephthalate, preferably 2,5-dihydroxyterephthalate (DHBDC).

According to a fifth alternative, it is preferred that the one or more organic ligands comprised in the metal-organic framework comprise, preferably consist of, one or more of phthalate, isophthalate, terephthalate, 2,6-naphthalenedicarboxylate, 1,4-naphthalenedicarboxylate, 1,5-naphthalenedicarboxylate, 1,2,3-benzenetricarboxylate, 1,2,4-benzenetricarboxylate, 1,3,5-benzenetricarboxylate, and 1,2,4,5-benzenetetracarboxylate.

It is preferred that from 99 to 100 weight-%, more preferably from 99.5 to 100, more preferably from 99.9 to 100 weight-%, of the metal-organic framework comprised in the molding consists of the one or more metal ions M and the one or more organic ligands.

It is preferred that the metal-organic framework comprised in the molding comprises M, C, O, and H.

In the case where the metal-organic framework comprised in the molding comprises M, C, O, and H, it is preferred that from 95 to 100 weight-%, more preferably from 97 to 100 weight-%, more preferably from 99 to 100 weight-% of the metal-organic framework consists of M, C, O, and H, wherein more preferably from 95 to 100 weight-%, more preferably from 97 to 100 weight-%, more preferably from 99 to 100 weight-% of the metal-organic framework consists of M, C, O, and H.

It is preferred that the metal-organic framework comprised in the molding is microporous, wherein the metal-organic framework more preferably comprises one or more pores formed by one or more one-dimensional channels having a diameter in the range of from 5 to 15 Angstrom, more preferably in the range of from 7 to 12 Angstrom.

It is preferred that the metal-organic framework comprised in the molding shows an orthorhombic crystal system, preferably determined according to Reference Example 1.

It is preferred that the metal-organic framework comprised in the molding shows an x-ray diffraction pattern comprising a peak having a maximum in the range of from 8° to 12° 2theta, preferably determined according to Reference Example 1.

It is preferred that the metal-organic framework comprised in the molding shows an x-ray diffraction pattern comprising at least the following peaks:

| Intensity (%) | Diffraction angle 2θ/° [Cu K(alpha 1)] |
|---|---|
| 100 | 9.5-11.5 |
| 6-12 | 13-17 |
| 19-24 | 20-22 |
| 16-21 | 31-33 |
| 9-15 | 42-43.5 |

wherein 100% relates to the intensity of the maximum peak in the x-ray powder diffraction pattern, wherein the x-ray diffraction pattern is preferably determined according to Reference Example 1.

It is preferred that the metal-organic framework comprised in the molding shows in the temperature programmed desorption of ammonia in the temperature range of from 100 to 500° C. an ammonia adsorption of equal to or smaller than 2.0 mmol/g, more preferably of equal to or smaller than 1.9 mmol/g, more preferably in the range of from 0.1 to 1.8 mmol/g, more preferably in the range of from 0.5 to 1.7 mmol/g, more preferably in the range of from 1.0 to 1.6 mmol/g, preferably determined according to Reference Example 4.

It is preferred that the metal-organic framework comprised in the molding shows in the temperature programmed desorption of ammonia in the temperature range of from 100 to 500° C. a first peak having a maximum in the range of from 100 to 300° C., more preferably in the range of from 180 to 250° C., more preferably in the range of from 210 to 220° C., preferably determined according to Reference Example 4.

It is preferred that the metal-organic framework comprised in the molding shows in the temperature programmed desorption of ammonia in the temperature range of from greater than 100 to 500° C. a second peak having a maximum in the range of from 225 to 400° C., more preferably in the range of from 280 to 360° C., more preferably in the range of from 310 to 325° C., preferably determined according to Reference Example 4.

It is preferred that the molding comprises the metal-organic framework in an amount in the range of from 0.5 to 20.0 weight-%, more preferably in the range of from 0.75 to 10.0 weight-%, more preferably in the range of from 1.0 to 5.0 weight-%, more preferably in the range of from 1.25 to 3.5 weight-%, more preferably in the range of from 1.5 to 3.0 weight-%, more preferably in the range of from 1.7 to 2.5 weight-%, more preferably in the range of from 1.8 to 2.2 weight-%, based on the total weight of the molding.

It is preferred that the metal-organic framework comprised in the molding shows a water adsorption in the range of from 0.1 to 70 weight-% when exposed to a relative humidity of 85%, more preferably in the range of from 0.25 to 60 weight-%, more preferably in the range of from 25.0 to 55.0 weight-%, more preferably in the range of from 35.0 to 52.0 weight-%, and more preferably in the range of from 45.0 to 50.0 weight-%, wherein the water adsorption is preferably determined according to Reference Example 3.

It is preferred that the metal-organic framework comprised in the molding has a Langmuir specific surface area of at least 1000 m²/g, more preferably of at least 1200 m²/g, more preferably in the range of from 1200 to 600 m²/g, preferably determined according to Reference Example 2.

It is preferred that the metal-organic framework comprised in the molding shows in the temperature programmed desorption of water a type IV isotherm, preferably determined according to Reference Example 3.

It is preferred that the molding comprises the polyester in an amount in the range of from 30 to 99.0 weight-%, more preferably in the range of from 32.5 to 97.5 weight-%, more preferably in the range of from 32.5 to 95 weight-%, more preferably in the range of from 35 to 85 weight-%, based on the total weight of the molding.

It is preferred that the polyester comprised in the molding preferably comprises a butanediol ester, more preferably a monoester or a diester, more preferably a 1,4-butanediol ester.

It is preferred that the polyester comprised in the molding comprises, preferably consists of, a poly(alkylene dicarboxylate) polyester, wherein the dicarboxylate of the poly(alkylene dicarboxylate) polyester comprises, preferably consists of, one or more of adipate, terephthalate, sebacate, azelate, succinate, and 2,5-furandicarboxylate, more preferably one or more of adipate and terephthalate, more preferably adipate terephthalate or terephthalate, wherein the alkylene preferably comprises, more preferably consists of, one or more of ethylene, propylene, and butylene.

It is preferred that the polyester comprised in the molding comprises one or more poly(alkylene) terephthalates, wherein the alkylene more preferably comprises from 2 to 10, preferably from 3 to 5 carbon atoms, wherein the alkylene more preferably is butylene, wherein the polyester comprises more preferably one or more of a poly(ethylene) terephthalate, a poly(propylene) terephthalate, and a poly(butylene) terephthalate, wherein the polyester more preferably comprises, preferably consists of, one or more poly(butylene) terephthalates.

In the case where the polyester comprised in the molding comprises one or more poly(alkylene) terephthalates, it is preferred that the polyester comprises the one or more poly(alkylene) terephthalates in an amount in the range of from 30 to 100 weight-%, more preferably in the range of from 50 to 100 weight-%, more preferably in the range of from 60 to 100 weight-%, based on the total weight of the polyester.

It is preferred that the polyester comprised in the molding has a viscosity number in the range of from 50 to 220, more preferably in the range of from 80 to 160, preferably determined according to ISO 1628-5:1998.

It is preferred that the polyester comprised in the molding has a melt-volume flow-rate in the range of from 10 to 160 cm³/g 600 s, more preferably in the range of from 30 to 125 cm³/g 600 s, more preferably in the range of from 40 to 115 cm³/g 600 s, preferably determined according to ISO 1133 for 250° C./2.16 kg, wherein the polyester preferably comprises, preferably consists of, a poly(butylene) terephthalate.

It is preferred that the polyester comprised in the molding comprises an amount of terminal carboxy groups equal to or less than 100 meq/kg of polyester, more preferably equal to or less than 50 meq/kg of polyester, more preferably equal to or less than 40 meq/kg of polyester.

It is preferred that the polyester comprised in the molding comprises Ti in an amount of equal to or less than 250 ppm, more preferably equal to or less than 200 ppm, more preferably equal to or less than 150 ppm.

It is preferred that the polyester comprised in the molding comprises a blend of a poly(alkylene) terephthalate and a further polyester, wherein the further polyester is different to the poly(alkylene) terephthalate.

It is preferred that the polyester comprised in the molding comprises a poly(alkylene) terephthalate and a fully aromatic polyester, more preferably a fully aromatic polyester of an aromatic dicarboxylic acid or a fully aromatic polyester of an aromatic dihydroxy compound.

In the case where the polyester comprised in the molding comprises a poly(alkylene) terephthalate and a fully aromatic polyester, it is preferred that the polyester comprises from 2 to 80 weight-% of the fully aromatic polyester.

It is preferred that the polyester comprised in the molding comprises a polycarbonate, more preferably a halide-free polycarbonate, more preferably a polycarbonate comprising a biphenol repeating unit.

In the case where the polyester comprised in the molding comprises a polycarbonate, it is preferred that the polycarbonate comprises a relative viscosity nrei in the range of from 1.10 to 1.50, preferably in the range of from 1.25 to 1.40.

Further in the case where the polyester comprised in the molding comprises a polycarbonate, it is preferred that the polycarbonate has an average molar mass M. (weight average molar mass) in the range of from 10000 to 200000 g/mol, more preferably in the range of from 20000 to 80000 g/mol, preferably determined according to Reference Example 5.

It is preferred that the molding further comprises an acrylic acid polymer, more preferably in an amount in the range of from 0.01 to 2 weight-%, more preferably in the range of from 0.05 to 1.5 weight-%, more preferably in the range of from 0.1 to 1 weight-%, based on the total weight of the molding.

In the case where the molding comprises an acrylic acid polymer, it is preferred that the acrylic acid polymer comprises acrylic acid units in an amount in the range of from 70 to 100 weight-%, more preferably in the range of from 85 to 100 weight-%, based on the total weight of the acrylic acid polymer, and wherein the acrylic acid polymer comprises an ethylenically unsaturated monomer different to acrylic acid, selected from the group consisting of monoethylenically unsaturated carboxylic acids, preferably in an amount in the range of from equal to or greater than 0 to 30 weight-%, more preferably in the range of from equal to or greater than 0 to 15 weight-%, wherein the monoethylenically unsaturated carboxylic acid comprises one or more of methacrylic acid, maleic acid, fumaric acid, itaconic acid, mesaconic acid, methylenemalonic acid, and citraconic acid.

Further in the case where the molding comprises an acrylic acid polymer, it is preferred that the acrylic acid polymer has an average molar mass M, (weight average molar mass) in the range of from 1000 to 100,000 g/mol, more preferably in the range of from 1000 to 12,000 g/mol, more preferably in the range of from 1,500 to 8,000 g/mol, more preferably in the range of from 3,500 to 6,500 g/mol, preferably determined according to Reference Example 5.

Further in the case where the molding comprises an acrylic acid polymer, it is preferred that the acrylic acid polymer has a pH of equal to or less than 4, more preferably of equal to or less than 3.

It is preferred that the molding further comprises one or more additives, wherein the additives are preferably selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, more preferably from the group consisting of glass fibers, minerals, impact-modifiers, fluorine-containing ethylene polymers, and a mixture of two or more thereof.

In the case where the molding further comprises one or more additives selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, it is preferred that the stabilizers comprise one or more of alkoxymethylmelamines, amino-substituted triazines, sterically hindered phenols, metal-containing compounds, alkaline earth metal silicates, alkaline earth metal glycerophosphates, polyamides, sterically hindered amines, wherein the metal-containing compounds preferably comprise one or more of potassium hydroxide, calcium hydroxide, magnesium hydroxide, and magnesium carbonate.

Further in the case where the molding further comprises one or more additives selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, it is preferred that the lubricants comprise an ester of a fatty acid and a polyol, wherein the fatty acid is more preferably an unsaturated fatty acid or a saturated fatty acid, wherein the saturated fatty acid is preferably selected from the group consisting of caprylic acid, capric acid, lauric acid, stearic acid, arachidic acid, behenic acid, lignoceric acid, cerotic acid, and a mixture of two or more thereof, wherein the saturated fatty acid more preferably comprises, more preferably consists of, stearic acid, wherein the unsaturated fatty acid is preferably selected from the group consisting of myristoleic acid, palmitoleic acid, sapienic acid, oleic acid, elaidic acid, vaccenic acid, linoleic acid, linoelaidic acid, alpha-linolenic acid, arachidonic acid, eicosapentaenoic acid, erucic acid, docosahexaenoic acid, and a mixture of two or more thereof, wherein the polyol is preferably selected from the group of triols, tetrols, pentols, hexols, and ammixture of two or more thereof, wherein the polyol more preferably comprises one or more of sorbitol, xylitol, erythritol, threitol, and pentaerythritol, wherein the polyol more preferably comprises, more preferably consists of, pentaerythritol.

Further in the case where the molding further comprises one or more additives selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, it is preferred that the molding comprises the lubricants in an amount in the range of from 0.20 to 1.00 weight-%, more preferably in the range of from 0.35 to 0.70 weight-%, more preferably in the range of from 0.39 to 0.66 weight-%, based on the total weight of the molding.

Further in the case where the molding further comprises one or more additives selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, it is preferred that the glass fibers comprise one or more of glass wovens, glass mats, glass nonwovens, glass filament rovings, and chopped glass filaments made from low-alkali E glass, wherein the glass fibers preferably have a diameter in the range of from 5 to 200 micrometer, more preferably in the range of from 8 to 50 micrometer.

Further in the case where the molding further comprises one or more additives selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, it is preferred that the impact-modifiers comprises one or more of an ethylene-propylene elastomer, an ethylene-propylene-diene elastomer, and an emulsion polymer.

In the case where the impact-modifiers comprises one or more of an ethylene-propylene elastomer, an ethylene-propylene-diene elastomer, and an emulsion polymer, it is preferred that the elastomer is homogeneously structured and has a core-shell structure, wherein the core-shell structure more preferably comprises a unit of one or more of 1,3-butadiene, isoprene, n-butyl acrylate, ethylhexyl acrylate, styrene acrylonitrile, and methyl methacrylate, for the core, and wherein the core-shell structure preferably comprises a unit of one or more of styrene acrylonitrile, methyl methacrylate, n-butyl acrylate, ethyl acrylate, methyl acrylate, 1,3-butadiene, isoprene, and ethylhexyl acrylate, for the shell.

Further in the case where the impact-modifiers comprises one or more of an ethylene-propylene elastomer, an ethylene-propylene-diene elastomer, and an emulsion polymer, it is preferred that the emulsion polymer is selected from the group consisting of n-butyl acrylate-(meth)acrylic acid copolymers, n-butyl acrylateglycidyl acrylate or n-butyl acrylate-glycidyl methacrylate copolymers.

Further in the case where the molding further comprises one or more additives selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, it is preferred that the fillers comprise one or more of carbon black, glass fibers, glass beads, amorphous silica, asbestos, calcium silicate, calcium metasilicate, magnesium carbonate, kaolin, chalk, powdered quartz, mica, barium sulfate, feldspar, aramid fibers, potassium titanate fibers, and acicular mineral fillers, more preferably acicular wollastonite.

Further in the case where the molding further comprises one or more additives selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, it is preferred that the molding comprises fluorine-containing ethylene polymers, wherein the fluorine-containing ethylene polymers more preferably comprise a fluorine content in the range of from 55 to 76 weight-%, more preferably in the range of from 70 to 76 weight-%, based on the total weight of the fluorine-containing ethylene polymers, wherein the fluorine-containing ethylene polymers preferably are one or more of polytetrafluoroethylene (PTFE), tetrafluoroethylene-hexafluoropropylene copolymers, and tetrafluoroethylene copolymers, wherein the molding preferably comprises the fluorine-containing ethylene polymers in an amount in the range of from equal to or greater than 0 to 2 weight-%, based on the total weight of the molding.

Further in the case where the molding further comprises one or more additives, it is preferred that the molding comprises the one or more additives in an amount in the range of from equal to or greater than 0 to 70 weight-%, based on the total weight of the molding, more preferably in the range of from 0.01 to 50 weight-%, more preferably in the range of from 0.1 to 30 weight-%, more preferably in the range of from 1 to 25 weight-%.

It is preferred that the molding is in the form of a powder, of a granule, or of an extrudate, wherein the extrudate is preferably a strand.

It is preferred that the molding has a total emission of volatile organic compounds of at most 50 ppm, more preferably of at most 20 ppm, more preferably of at most 15 ppm, more preferably of at most 10 ppm.

Further, the present invention relates to a process for the preparation of a molding comprising a polyester and a metal-organic framework, preferably of a molding according to any one of the embodiments disclosed herein, said process comprising
(i) Preparing a mixture comprising a polyester in an amount in the range of from 25 to 99.99 weight-%, based on the total weight of the mixture, a metal-organic framework in an amount of from 0.01 to 25 weight-%, based on the total weight of the mixture, and optionally one or more additives in an amount in the range of from equal to or greater than 0 to 70 weight-%, based on the total weight of the mixture;
(ii) Shaping the mixture obtained from (i);
   wherein the metal-organic framework comprises one or more metal ions M and one or more organic ligands.

It is preferred that the mixture according to (i) of the process is performed in a mixer.

It is preferred that preparing the mixture according to (i) of the process is performed at a temperature of the mixture in the range of from 200 to 300° C., more preferably in the range of from 225 to 290° C., more preferably in the range of from 230 to 280° C.

It is preferred that shaping according to (ii) of the process comprises extruding the mixture obtained from (i), preferably with an extruder, more preferably a twin-screw-extruder.

It is preferred that the mixture is shaped in (ii) of the process to a granule or an extrudate, wherein the mixture is more preferably shaped in (ii) to a strand.

It is preferred that the one or more metal ions M of the process are selected from groups 2, 11, 12, 13 of the periodic system of elements, and combinations of two or more thereof, wherein the one or more metal ions M more preferably are selected from the group consisting of Al, Ga, Cu, Ag, Zn, Mg, Mn, Ti, Fe, and combinations of two or more thereof, wherein the one or more metal ions M more preferably are one or more of Al and Zn, wherein the one or more metal ions M more preferably are Al, wherein the one or more metal ions M are preferably positively charged.

It is preferred that the metal-organic framework of the process comprises the one or more metal ions M in an amount in the range of from 10 to 25 weight-%, preferably in the range of from 15 to 20 weight-%, more preferably in the range of from 16.0 to 17.6 weight-%, more preferably in the range of from 16.2 to 17.2 weight-%, more preferably in the range of from 16.4 to 17.0 weight-%, based on the total weight of the metal-organic framework.

It is preferred that the one or more organic ligands of the metal-organic framework of the process are coordinated to the one or more metal ions M, more preferably as a bidentate ligand of the one or more metal ions M.

It is preferred that the one or more organic ligands of the metal-organic framework of the process are negatively charged, wherein the one or more organic ligands preferably comprise, more preferably consist of, one or more of monoanions, dianions, trianions, and tetraanions, more preferably one or more of dicarboxylates, tricarboxylates, and tetracarboxylates.

It is preferred that the one or more organic ligands of the metal-organic framework of the process comprise, preferably consist of, one or more of oxalate, succinate, tartrate, 1,4-butanedicarboxylate, 1,4-butenedicarboxylate, 4-oxopyran-2,6-dicarboxylate, 1,6-hexanedicarboxylate, decanedicarboxylate, 1,8-heptadecanedicarboxylate, 1,9-heptadecanedicarboxylate, heptadecanedicarboxylate, acetylenedicarboxylate, 1,2-benzenedicarboxylate, 1,3-benzenedicarboxylate, 2,3-pyridinedicarboxylate, pyridine-2,3-dicarboxylate, 1,3-butadiene-1,4-dicarboxylate, 1,4-benzenedicarboxylate, p-benzenedicarboxylate, imidazole-2,4-dicarboxylate, 2-methylquinoline-3,4-dicarboxylate, quinoline-2,4-dicarboxylate, quinoxaline-2,3-dicarboxylate, 6-chloroquinoxaline-2,3-dicarboxylate, 4,4′-diaminophenylmethane-3,3′-dicarboxylate, quinoline-3,4-dicarboxylate, 7-chloro-4-hydroxyquinoline-2,8-dicarboxylate, diimidedicarboxylate, pyridine-2,6-dicarboxylate, 2-methylimidazole-4,5-dicarboxylate, thiophene-3,4-dicarboxylate, 2-isopropylimidazole-4,5-dicarboxylate, tetrahydropyran-4,4-dicarboxylate, perylene-3,9-dicarboxylate, perylenedicarboxylate, Pluriol E 200-dicarboxylate, 3,6-dioxaoctanedicarboxylate, 3,5-cyclohexadiene-1,2-dicarboxylate, octanedicarboxylate, pentane-3,3-carboxylate, 4,4′-diamino-1,1′-biphenyl-3,3′-dicarboxylate, 4,4′-diaminobiphenyl-3,3′-dicarboxylate, benzidine-3,3′-dicarboxylate, 1,4-bis(phenylamino)benzene-2,5-dicarboxylate, 1,1′-binaphthyldicarboxylate, 7-chloro-8-methylquinoline-2,3-dicarboxylate, 1-anilinoanthraquinone-2,4′-dicarboxylate, polytetrahydrofuran 250-dicarboxylate, 1,4-bis(carboxymethyl)piperazine-2,3-dicarboxylate, 7-chloroquinoline-3,8-dicarboxylate, 1-(4-carboxy)phenyl-3-(4-chloro)phenylpyrazoline-4,5-dicarboxylate, 1,4,5,6,7,7-hexachloro-5-norbornene-2,3-dicarboxylate, phenylindanedicarboxylate, 1,3-dibenzyl-2-oxoimidazolidine-4,5-dicarboxylate, 1,4-cyclohexanedicarboxylate, naphthalene-1,8-dicarboxylate, 2-benzoylbenzene-1,3-dicarboxylate, 1,3-dibenzyl-2-oxoimidazolidine-4,5-cis-dicarboxylate, 2,2′-biquinoline-4,4′-dicarboxylate, pyridine-3,4-dicarboxylate, 3,6,9-trioxaundecanedicarboxylate, hydroxybenzophenonedicarboxylate, Pluriol E 300-dicarboxylate, Pluriol E 400-dicarboxylate, Pluriol E 600-dicarboxylate, pyrazole-3,4-dicarboxylate, 2,3-pyrazinedicarboxylate, 5,6-dimethyl-2,3-pyrazinedicarboxylate, bis(4-aminophenyl) ether diimide-dicarboxylate, 4,4′-diaminodiphenylmethane diimide-dicarboxylate, bis(4-aminophenyl) sulfone diimide-dicarboxylate, 1,4-naphthalenedicarboxylate, 2,6-naphthalene-dicarboxylate, 1,3-adamantanedicarboxylate, 1,8-naphthalenedicarboxylate, 2,3-naphthalenedicarboxylate, 8-methoxy-2,3-naphthalenedicarboxylate, 8-nitro-2,3-naphthalenecarboxylate, 8-sulfo-2,3-naphthalenedicarboxylate, anthracene-2,3-dicarboxylate, 2′,3′-diphenyl-p-terphenyl-4,4″-dicarboxylate, (diphenyl ether)-4,4′-dicarboxylate, imidazole-4,5-dicarboxylate, 4(1H)-oxothiochromene-2,8-dicarboxylate, 5-tert-butyl-1,3-benzenedicarboxylate, 7,8-quinolinedicarboxylate, 4,5-imidazoledicarboxylate, 4-cyclohexene-1,2-dicarboxylate, hexatriacontanedicarboxylate, tetradecanedicarboxylate, 1,7-heptanedicarboxylate, 5-hydroxy-1,3-benzenedicarboxylate, 2,5-dihydroxy-1,4-benzenedicarboxylate, pyrazine-2,3-dicarboxylate, furan-2,5-dicarboxylate, 1-nonene-6,9-dicarboxylate, eicosenedicarboxylate, 4,4′-dihydroxy-diphenylmethane-3,3′-dicarboxylate, 1-amino-4-methyl-9,10-dioxo-9,10-dihydroanthracene-2,3-dicarboxylate, 2,5-pyridinedicarboxylate, cyclohexene-2,3-dicarboxylate, 2,9-dichlorofluorubin-4,11-dicarboxylate, 7-chloro-3-methylquinoline-6,8-dicarboxylate, 2,4-dichlorobenzophenone-2′,5′-dicarboxylate, 1,3-benzenedicarboxylate, 2,6-pyridinedicarboxylate, 1-methylpyrrol-3,4-dicarboxylate, 1-benzyl-1H-pyrrol-3,4-dicarboxylate, anthraquinone-1,5-dicarboxylate, 3,5-pyrazoledicarboxylate, 2-nitrobenzene-1,4-dicarboxylate, heptane-1,7-dicarboxylate, cyclobutane-1,1-dicarboxylate, 1,14-tetradecanedicarboxylate, 5,6-dehydronorbornane-2,3-dicarboxylate, 5-ethyl-2,3-pyridinedicarboxylate, and camphordicarboxylate.

It is preferred that the one or more organic ligands of the metal-organic framework of the process comprise, preferably consist of, one or more of 2-Hydroxy-1,2,3-propanetricarboxylate, 7-chloro-2,3,8-quinolinetricarboxylate, 1,2,3-benzenetricarboxylate, 1,2,4-benzenetricarboxylate, 1,2,4-butanetricarboxylate, 2-phosphono-1,2,4-butanetricarboxylate, 1,3,5-benzenetricarboxylate, 1-hydroxy-1,2,3-propanetricarboxylate, 4,5-dihydroxy-4,5-dioxo-1H-pyrrolo[2,3-f]quinoline-2,7,9-tricarboxylate, 5-acetyl-3-amino-6-methylbenzene-1,2,4-tricarboxylate, 3-amino-5-benzoyl-6-methylbenzene-1,2,4-tricarboxylate, 1,2,3-propanetricarboxylate, and aurintricarboxylate.

It is preferred that the one or more organic ligands of the metal-organic framework of the process comprise, preferably consist of, one or more of 1,1-Dioxidoperylo[1,12-BCD]thiophene-3,4,9,10-tetracarboxylate, a perylenetetracarboxylate, preferably perylene-3,4,9,10-tetracarboxylate or (perylene-1,12-sulfone)-3,4,9,10-tetracarboxylate, a butanetetracarboxylate, preferably 1,2,3,4-butanetetracarboxylate or meso-1,2,3,4-butanetetracarboxylate, decane-2,4,6,8-tetracarboxylate, 1,4,7,10,13,16-hexaoxacyclooctadecane-2,3,11,12-tetracarboxylate, 1,2,4,5-benzenetetracarboxylate, 1,2,11,12-dodecanetetracarboxylate, 1,2,5,6-hexanetetracarboxylate, 1,2,7,8-octanetetracarboxylate, 1,4,5,8-naphthalenetetracarboxylate, 1,2,9,10-decanetetracarboxylate, benzophenonetetracarboxylate, 3,3′,4,4′-benzophenonetetracarboxylate, tetrahydrofurantetracarboxylate, and a cyclopentanetetracarboxylate, preferably cyclopentane-1,2,3,4-tetracarboxylate.

It is preferred that the one or more organic ligands of the metal-organic framework of the process comprise, preferably consist of, one or more of acetylenedicarboxylate (ADC), camphordicarboxylate, fumarate, succinate, a benzenedicarboxylate, an naphthalenedicarboxylate, a biphenyldicarboxylate, preferably 4,4′-biphenyldicarboxylate (BPDC), a pyrazinedicarboxylate, preferably 2,5-pyrazinedicarboxylate, a bipyridinedicarboxylate, preferably a 2,2′-bipyridinedicarboxylate, more preferably 2,2′-bipyridine-5,5′-dicarboxylate, a benzenetricarboxylate, preferably one or more of 1,2,3-benzenetricarboxylate, 1,2,4-benzenetricarboxylate, and 1,3,5-benzenetricarboxylate (BTC), benzenetetracarboxylate, adamantanetetracarboxylate (ATC), adamantanedibenzoate (ADB), benzenetribenzoate (BTB), methanetetrabenzoate (MTB), adamantanetetrabenzoate, and a dihydroxyterephthalate, preferably 2,5-dihydroxyterephthalate (DHBDC).

It is preferred that the one or more organic ligands of the metal-organic framework of the process comprise, preferably consist of, one or more of phthalate, isophthalate, terephthalate, 2,6-naphthalenedicarboxylate, 1,4-naphthalenedicarboxylate, 1,5-naphthalenedicarboxylate, 1,2,3-benzenetricarboxylate, 1,2,4-benzenetricarboxylate, 1,3,5-benzenetricarboxylate, and 1,2,4,5-benzenetetracarboxylate.

It is preferred that from 99 to 100 weight-%, more preferably from 99.5 to 100, more preferably from 99.9 to 100 weight-%, of the metal-organic framework of the process consists of the one or more metal ions M and the one or more organic ligands.

It is preferred that the metal-organic framework of the process comprises M, C, O, and H.

In the case where the metal-organic framework of the process comprises M, C, O, and H, it is preferred that from 95 to 100 weight-%, more preferably from 97 to 100 weight-%, more preferably from 99 to 100 weight-% of the metal-organic framework consists of M, C, O, and H, wherein more preferably from 95 to 100 weight-%, more preferably from 97 to 100 weight-%, more preferably from 99 to 100 weight-% of the metal-organic framework consists of M, C, O, and H.

It is preferred that the metal-organic framework of the process is microporous, wherein the metal-organic framework more preferably comprises one or more pores formed by one or more one-dimensional channels having a diameter in the range of from 5 to 15 Angstrom, preferably in the range of from 7 to 12 Angstrom.

It is preferred that the metal-organic framework of the process shows an orthorhombic crystal system, preferably determined according to Reference Example 1.

It is preferred that the metal-organic framework of the process shows an x-ray diffraction pattern comprising a peak having a maximum in the range of from 8° to 12° 2theta, preferably determined according to Reference Example 1.

It is preferred that the metal-organic framework of the process shows an x-ray diffraction pattern comprising at least the following peaks:

| Intensity (%) | Diffraction angle 2θ/° [Cu K(alpha 1)] |
|---|---|
| 100 | 9.5-11.5 |
| 6-12 | 13-17 |
| 19-24 | 20-22 |
| 16-21 | 31-33 |
| 9-15 | 42-43.5 |

wherein 100% relates to the intensity of the maximum peak in the x-ray powder diffraction pattern, wherein the x-ray diffraction pattern is preferably determined according to Reference Example 1.

It is preferred that the metal-organic framework of the process shows in the temperature programmed desorption of ammonia in the temperature range of from 100 to 500° C. an ammonia adsorption of equal to or smaller than 2.0 mmol/g, more preferably of equal to or smaller than 1.9 mmol/g, more preferably in the range of from 0.1 to 1.8 mmol/g, more preferably in the range of from 0.5 to 1.7 mmol/g, more preferably in the range of from 1.0 to 1.6 mmol/g, preferably determined according to Reference Example 4.

It is preferred that the metal-organic framework of the process shows in the temperature programmed desorption of ammonia in the temperature range of from 100 to 500° C. a first peak having a maximum in the range of from 100 to 300° C., more preferably in the range of from 180 to 250° C., more preferably in the range of from 210 to 220° C., preferably determined according to Reference Example 4.

It is preferred that the metal-organic framework of the process shows in the temperature programmed desorption of ammonia in the temperature range of from greater than 100 to 500° C. a second peak having a maximum in the range of from 225 to 400° C., more preferably in the range of from 280 to 360° C., more preferably in the range of from 310 to 325° C., preferably determined according to Reference Example 4.

It is preferred that the mixture prepared in (i) of the process comprises the metal-organic framework in an amount in the range of from 0.5 to 20.0 weight-%, more preferably in the range of from 0.75 to 10.0 weight-%, more preferably in the range of from 1.0 to 5.0 weight-%, more preferably in the range of from 1.25 to 3.5 weight-%, more preferably in the range of from 1.5 to 3.0 weight-%, more preferably in the range of from 1.7 to 2.5 weight-%, more preferably in the range of from 1.8 to 2.2 weight-%, based on the total weight of the mixture.

It is preferred that the metal-organic framework of the process shows a water adsorption in the range of from 0.1 to 70 weight-% when exposed to a relative humidity of 85%, more preferably in the range of from 0.25 to 60 weight-%, more preferably in the range of from 25.0 to 55.0 weight-%, more preferably in the range of from 35.0 to 52.0 weight-%, and more preferably in the range of from 45.0 to 50.0 weight-%, wherein the water adsorption is preferably determined according to Reference Example 3.

It is preferred that the metal-organic framework of the process has a Langmuir specific surface area of at least 1000 m²/g, more preferably of at least 1200 m²/g, more preferably in the range of from 1200 to 600 m²/g, preferably determined according to Reference Example 2.

It is preferred that the metal-organic framework of the process shows in the temperature programmed desorption of water a type IV isotherm, preferably determined according to Reference Example 3.

It is preferred that the mixture prepared in (i) of the process comprises the polyester in an amount in the range of from 30 to 99.0 weight-%, more preferably in the range of from 32.5 to 97.5 weight-%, more preferably in the range of from 32.5 to 95 weight-%, more preferably in the range of from 35 to 85 weight-%, based on the total weight of the mixture.

It is preferred that the polyester of the process comprises a butanediol ester, more preferably a monoester or a diester, more preferably a 1,4-butanediol ester.

It is preferred that the polyester of the process comprises, preferably consists of, a poly(alkylene dicarboxylate) polyester, wherein the dicarboxylate of the poly(alkylene dicarboxylate) polyester comprises, preferably consists of, one or more of adipate, terephthalate, sebacate, azelate, succinate, and 2,5-furandicarboxylate, preferably one or more of adipate and terephthalate, more preferably adipate terephthalate or terephthalate, wherein the alkylene preferably comprises, more preferably consists of, one or more of ethylene, propylene, and butylene.

It is preferred that the polyester of the process comprises one or more poly(alkylene) terephthalates, wherein the alkylene preferably comprises from 2 to 10, more preferably from 3 to 5 carbon atoms, wherein the alkylene more preferably is butylene, wherein the polyester comprises more preferably one or more of a poly(ethylene) terephthalate, a poly(propylene) terephthalate, and a poly(butylene) terephthalate, wherein the polyester more preferably comprises, preferably consists of, one or more poly(butylene) terephthalates.

In the case where the polyester of the process comprises one or more poly(alkylene) terephthalates, it is preferred that the polyester comprises the one or more poly(alkylene) terephthalates in an amount in the range of from 30 to 100 weight-%, preferably in the range of from 50 to 100 weight-%, more preferably in the range of from 60 to 100 weight-%, based on the total weight of the polyester.

It is preferred that the polyester of the process has a viscosity number in the range of from 50 to 220, more preferably in the range of from 80 to 160, preferably determined according to ISO 1628-5:1998.

It is preferred that the polyester of the process has a melt-volume flow-rate in the range of from 10 to 160 cm³/g 600 s, more preferably in the range of from 30 to 125 cm³/g 600 s, more preferably in the range of from 40 to 115 cm³/g 600 s, preferably determined according to ISO 1133 for 250° C./2.16 kg, wherein the polyester preferably comprises, preferably consists of, a poly(butylene) terephthalate.

It is preferred that the polyester of the process comprises an amount of terminal carboxy groups equal to or less than 100 meq/kg of polyester, more preferably equal to or less than 50 meq/kg of polyester, more preferably equal to or less than 40 meq/kg of polyester.

It is preferred that the polyester of the process comprises Ti in an amount of equal to or less than 250 ppm, more preferably equal to or less than 200 ppm, more preferably equal to or less than 150 ppm.

It is preferred that the polyester of the process comprises a blend of a poly(alkylene) terephthalate and a further polyester, wherein the further polyester is different to the poly(alkylene) terephthalate.

It is preferred that the polyester of the process comprises a poly(alkylene) terephthalate and a fully aromatic polyester, more preferably a fully aromatic polyester of an aromatic dicarboxylic acid or a fully aromatic polyester of an aromatic dihydroxy compound.

In the case where the polyester of the process comprises a poly(alkylene) terephthalate and a fully aromatic polyester, it is preferred that the polyester comprises from 20 to 98 weight-% of the poly(alkylene) terephthalate and from 2 to 80 weight-% of the fully aromatic polyester.

It is preferred that the polyester of the process comprises a polycarbonate, more preferably a halide-free polycarbonate, more preferably a polycarbonate comprising a biphenol repeating unit.

In the case where the polyester of the process comprises a polycarbonate, it is preferred that the polycarbonate comprises a relative viscosity nᵣₑₗ in the range of from 1.10 to 1.50, more preferably in the range of from 1.25 to 1.40.

Further in the case where the polyester of the process comprises a polycarbonate, it is preferred that the polycarbonate has an average molar mass M, (weight average molar mass) in the range of from 10000 to 200000 g/mol, more preferably in the range of from 20000 to 80000 g/mol, preferably determined according to Reference Example 5.

It is preferred that the mixture prepared in (i) of the process further comprises an acrylic acid polymer, more preferably in an amount in the range of from 0.01 to 2 weight-%, more preferably in the range of from 0.05 to 1.5 weight-%, more preferably in the range of from 0.1 to 1 weight-%, based on the total weight of the mixture prepared in (i).

In the case where the mixture prepared in (i) of the process further comprises an acrylic acid polymer, it is preferred that the acrylic acid polymer comprises acrylic acid units in an amount in the range of from 70 to 100 weight-%, more preferably in the range of from 85 to 100 weight-%, based on the total weight of the acrylic acid polymer, and wherein the acrylic acid polymer more preferably comprises an ethylenically unsaturated monomer different to acrylic acid, preferably selected from the group consisting of monoethylenically unsaturated carboxylic acids, more preferably in an amount in the range of from equal to or greater than 0 to 30 weight-%, more preferably in the range of from equal to or greater than 0 to 15 weight-%, wherein the monoethylenically unsaturated carboxylic acid more preferably comprises one or more of methacrylic acid, maleic acid, fumaric acid, itaconic acid, mesaconic acid, methylenemalonic acid, and citraconic acid.

Further in the case where the mixture prepared in (i) of the process further comprises an acrylic acid polymer, it is preferred that the acrylic acid polymer has an average molar mass M_{w} (weight average molar mass) in the range of from 1000 to 100,000 g/mol, preferably in the range of from 1000 to 12,000 g/mol, more preferably in the range of from 1,500 to 8,000 g/mol, more preferably in the range of from 3,500 to 6,500 g/mol, preferably determined according to Reference Example 5.

Further in the case where the mixture prepared in (i) of the process further comprises an acrylic acid polymer, it is preferred that the acrylic acid polymer has a pH of equal to or less than 4, more preferably of equal to or less than 3.

It is preferred that the mixture prepared in (i) of the process comprises one or more additives, wherein the one or more additives are preferably selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, more preferably from the group consisting of glass fibers, minerals, impact-modifiers, fluorine-containing ethylene polymers, and a mixture of two or more thereof.

In the case where the one or more additives are selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, it is preferred that the stabilizers comprise one or more of alkoxymethylmelamines, amino-substituted triazines, sterically hindered phenols, metal-containing compounds, alkaline earth metal silicates, alkaline earth metal glycerophosphates, polyamides, sterically hindered amines, wherein the metal-containing compounds preferably comprise one or more of potassium hydroxide, calcium hydroxide, magnesium hydroxide, and magnesium carbonate.

Further in the case where the one or more additives are selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, it is preferred that the lubricants comprise an ester of a fatty acid and a polyol, wherein the fatty acid is preferably an unsaturated fatty acid or a saturated fatty acid, wherein the saturated fatty acid is preferably selected from the group consisting of caprylic acid, capric acid, lauric acid, stearic acid, arachidic acid, behenic acid, lignoceric acid, cerotic acid, and a mixture of two or more thereof, wherein the saturated fatty acid more preferably comprises, more preferably consists of, stearic acid, wherein the unsaturated fatty acid is preferably selected from the group consisting of myristoleic acid, palmitoleic acid, sapienic acid, oleic acid, elaidic acid, vaccenic acid, linoleic acid, linoelaidic acid, alpha-linolenic acid, arachidonic acid, eicosapentaenoic acid, erucic acid, docosahexaenoic acid, and a mixture of two or more thereof, wherein the polyol is preferably selected from the group of triols, tetrols, pentols, hexols, and ammixture of two or more thereof, wherein the polyol more preferably comprises one or more of sorbitol, xylitol, erythritol, threitol, and pentaerythritol, wherein the polyol more preferably comprises, more preferably consists of, pentaerythritol.

Further in the case where the one or more additives are selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, it is preferred that the mixture prepared in (i) comprises the lubricants in an amount in the range of from 0.20 to 1.00 weight-%, more preferably in the range of from 0.35 to 0.70 weight-%, more preferably in the range of from 0.39 to 0.66 weight-%, based on the total weight of the mixture.

Further in the case where the one or more additives are selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, it is preferred that the glass fibers comprise one or more of glass wovens, glass mats, glass nonwovens, glass filament rovings, and chopped glass filaments made from low-alkali E glass, wherein the glass fibers more preferably have a diameter in the range of from 5 to 200 micrometer, more preferably in the range of from 8 to 50 micrometer.

Further in the case where the one or more additives are selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, it is preferred that the impact-modifiers comprises one or more of an ethylene-propylene elastomer, an ethylene-propylene-diene elastomer, and an emulsion polymer.

Further in the case where the one or more additives are selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, it is preferred that the impact-modifiers comprises one or more of an ethylene-propylene elastomer, an ethylene-propylene-diene elastomer, and an emulsion polymer, it is preferred that the elastomer is homogeneously structured and has a core-shell structure, wherein the core-shell structure more preferably comprises a unit of one or more of 1,3-butadiene, isoprene, n-butyl acrylate, ethylhexyl acrylate, styrene acrylonitrile, and methyl methacrylate, for the core, and wherein the core-shell structure preferably comprises a unit of one or more of styrene acrylonitrile, methyl methacrylate, n-butyl acrylate, ethyl acrylate, methyl acrylate, 1,3-butadiene, isoprene, and ethylhexyl acrylate, for the shell.

Further in the case where the one or more additives are selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, it is preferred that the impact-modifiers comprises one or more of an ethylene-propylene elastomer, an ethylene-propylene-diene elastomer, and an emulsion polymer, it is preferred that the emulsion polymer is selected from the group consisting of n-butyl acrylate-(meth)acrylic acid copolymers, n-butyl acrylateglycidyl acrylate or n-butyl acrylate-glycidyl methacrylate copolymers.

Further in the case where the one or more additives are selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, it is preferred that the impact-modifiers comprises one or more of an ethylene-propylene elastomer, an ethylene-propylene-diene elastomer, and an emulsion polymer, it is preferred that the fillers comprise one or more of carbon black, glass fibers, glass beads, amorphous silica, asbestos, calcium silicate, calcium metasilicate, magnesium carbonate, kaolin, chalk, powdered quartz, mica, barium sulfate, feldspar, aramid fibers, potassium titanate fibers, and acicular mineral fillers, more preferably acicular wollastonite.

Further in the case where the one or more additives are selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, it is preferred that the impact-modifiers comprises one or more of an ethylene-propylene elastomer, an ethylene-propylene-diene elastomer, and an emulsion polymer, it is preferred that the mixture prepared in (i) comprises a fluorine-containing ethylene polymer, more preferably a fluorine-containing ethylene polymer comprising a fluorine content in the range of from 55 to 76 weight-%, more preferably in the range of from 70 to 76 weight-%, based on the total weight of the fluorine-containing ethylene polymer, wherein the fluorine-containing ethylene polymer more preferably is one or more of polytetrafluoroethylene (PTFE), tetrafluoroethylene-hexafluoropropylene copolymers, and tetrafluoroethylene copolymers, wherein the mixture more preferably comprises the fluorine-containing ethylene polymer in an amount in the range of from equal to or greater than 0 to 2 weight-%, based on the total weight of the mixture.

It is preferred that the mixture prepared in (i) of the process comprises the one or more additives in an amount in the range of from equal to or greater than 0 to 70 weight-%, based on the total weight of the mixture, more preferably in the range of from 0.01 to 50 weight-%, more preferably in the range of from 0.1 to 30 weight-%, more preferably in the range of from 1 to 25 weight-%.

It is preferred that the metal-organic framework according to (i) is prepared according to a process comprising
(a) preparing a mixture comprising one or more sources of one or more metal ions M, one or more sources of one or more organic ligands, and optionally a solvent system;
(b) subjecting the mixture obtained from (a) in a gas atmosphere to reaction conditions;
(c) optionally isolating the metal-organic framework from the mixture obtained from (ii).

In the case where the process further comprises (a), (b), and optionally (c), it is preferred that M is selected from groups 2, 11, 12, 13 of the periodic system of elements, and combinations of two or more thereof, wherein M more preferably is selected from the group consisting of Al, Ga, Cu, Ag, Zn, Mg, Mn, Ti, Fe, and combinations of two or more thereof, wherein M more preferably is one or more of Al and Zn, wherein M more preferably is Al.

Further in the case where the process further comprises (a), (b), and optionally (c), it is preferred that the one or more sources of one or more metal ions M are one or more of an alkoxide, an acetylacetonate, a halide, a sulfite, a salt of an organic acid and a salt of an inorganic acid.

In the case where the one or more sources of one or more metal ions M are one or more of an alkoxide, an acetylacetonate, a halide, a sulfite, a salt of an organic acid and a salt of an inorganic acid, it is preferred that the alkoxide is one or more of methoxide, ethoxide, n-propoxide, i-propoxide, n-butoxide, t-butoxide, and phenolate.

Further in the case where the one or more sources of one or more metal ions M are one or more of an alkoxide, an acetylacetonate, a halide, a sulfite, a salt of an organic acid and a salt of an inorganic acid, it is preferred that the halide is one or more of a chloride, a bromide, and an iodide.

Further in the case where the one or more sources of one or more metal ions M are one or more of an alkoxide, an acetylacetonate, a halide, a sulfite, a salt of an organic acid and a salt of an inorganic acid, it is preferred that the organic acid of the salt of the organic acid comprises oxygen, wherein the organic acid more preferably is one or more of formic acid, acetic acid, propionic acid, and an alkyl monocarboxylic acid.

Further in the case where the one or more sources of one or more metal ions M are one or more of an alkoxide, an acetylacetonate, a halide, a sulfite, a salt of an organic acid and a salt of an inorganic acid, it is preferred that the inorganic acid of the salt of the inorganic acid comprises oxygen, wherein the inorganic acid more preferably is one or more of sulfuric acid, sulfurous acid, phosphoric acid, and nitric acid.

In the case where the one or more sources of one or more metal ions M are one or more of an alkoxide, an acetylacetonate, a halide, a sulfite, a salt of an organic acid and a salt of an inorganic acid, and wherein M is Al, it is preferred that the one or more sources of Al ions are an aluminum containing salt, more preferably one or more of aluminum chloride, aluminum bromide, aluminum hydrogensulfate, aluminum dihydrogenphosphate, aluminum monohydrogenphosphate, aluminum phosphate, aluminum nitrate, sodium aluminate, and potassium aluminate, wherein the one or more sources of Al ions more preferably are aluminum sulfate, more preferably aluminum sulfate octahydrate or aluminum sulfate tetrahydrate.

Further in the case where the process further comprises (a), (b), and optionally (c), it is preferred that the one or more sources of one or more organic ligands comprise, preferably consist of, an organic compound or a salt of an organic compound, wherein the one or more sources of one or more organic ligands more preferably comprise, preferably consist of, a salt of an organic compound, preferably one or more of a sodium salt, a potassium salt, and an ammonium salt.

Further in the case where the process further comprises (a), (b), and optionally (c), it is preferred that the one or more sources of one or more organic ligands comprises one or more of a dicarboxylic acid, a tricarboxylic acid, and a tetracarboxylic acid.

In the case where the one or more sources of one or more organic ligands comprises one or more of a dicarboxylic acid, a tricarboxylic acid, and a tetracarboxylic acid, it is preferred that one or more of the dicarboxylic acid, the tricarboxylic acid, and the tetracarboxylic acid is substituted with one or more of —OH, —NH₂, —OCH₃, —CH₃, —NH(CH₃), —N(CH₃)₂, —CN, —SO₃H, and a halide.

Further in the case where the one or more sources of one or more organic ligands comprises one or more of a dicarboxylic acid, a tricarboxylic acid, and a tetracarboxylic acid, it is preferred that one or more of the dicarboxylic acid, the tricarboxylic acid, and the tetracarboxylic acid is present in the form of the sulfur analogue.

the case where the one or more sources of one or more organic ligands comprises one or more of a dicarboxylic acid, a tricarboxylic acid, and a tetracarboxylic acid, it is preferred that one or more of the dicarboxylic acid, the tricarboxylic acid, and the tetracarboxylic acid comprises a saturated aliphatic backbone, an unsaturated aliphatic backbone, an aromatic backbone, or a mixed aliphatic-aromatic backbone, wherein the aliphatic part of the backbone is saturated or unsaturated.

In the case where one or more of the dicarboxylic acid, the tricarboxylic acid, and the tetracarboxylic acid comprises a saturated aliphatic backbone, an unsaturated aliphatic backbone, an aromatic backbone, or a mixed aliphatic-aromatic backbone, wherein the aliphatic part of the backbone is saturated or unsaturated, it is preferred that the saturated aliphatic backbone, the unsaturated aliphatic backbone, or the aliphatic part of the backbone is linear, branched, or cyclic.

Further in the case where one or more of the dicarboxylic acid, the tricarboxylic acid, and the tetracarboxylic acid comprises a saturated aliphatic backbone, an unsaturated aliphatic backbone, an aromatic backbone, or a mixed aliphatic-aromatic backbone, wherein the aliphatic part of the backbone is saturated or unsaturated, it is preferred that the saturated aliphatic backbone, the unsaturated aliphatic backbone, or the aliphatic part of the backbone comprises from 1 to 18, preferably from 2 to 14, more preferably from 3 to 13, more preferably from 4 to 12, more preferably from 5 to 11, more preferably from 6 to 10, more preferably from 7 to 9, more preferably from 7 to 8 carbon atoms.

Further in the case where one or more of the dicarboxylic acid, the tricarboxylic acid, and the tetracarboxylic acid comprises a saturated aliphatic backbone, an unsaturated aliphatic backbone, an aromatic backbone, or a mixed aliphatic-aromatic backbone, wherein the aliphatic part of the backbone is saturated or unsaturated, it is preferred that the saturated aliphatic backbone, the unsaturated aliphatic backbone, or the aliphatic part of the backbone comprises methane, adamantine, acetylene, ethylene, or butadiene.

Further in the case where one or more of the dicarboxylic acid, the tricarboxylic acid, and the tetracarboxylic acid comprises a saturated aliphatic backbone, an unsaturated aliphatic backbone, an aromatic backbone, or a mixed aliphatic-aromatic backbone, wherein the aliphatic part of the backbone is saturated or unsaturated, it is preferred that the aromatic backbone or the aromatic part of the mixed aliphatic-aromatic backbone comprises one or more rings, preferably two, three, four or five rings, wherein one or more rings comprise one or more heteroatoms selected from the group consisting of N, O, S, B, P, Si, and combinations of two or more thereof, preferably selected from the group consisting of N, O, Si, and combinations of two or more thereof.

Further in the case where one or more of the dicarboxylic acid, the tricarboxylic acid, and the tetracarboxylic acid comprises a saturated aliphatic backbone, an unsaturated aliphatic backbone, an aromatic backbone, or a mixed aliphatic-aromatic backbone, wherein the aliphatic part of the backbone is saturated or unsaturated, it is preferred that the aromatic backbone or the aromatic part of the mixed aliphatic-aromatic backbone comprises one or more of phenyl, naphthyl, biphenyl, bipyridyl, and pyridyl.

Further in the case where the process further comprises (a), (b), and optionally (c), it is preferred that the one or more sources of one or more organic ligands comprises, preferably consists of, a dicarboxylic acid, preferably one or more of oxalic acid, succinic acid, tartaric acid, 1,4-butanedicarboxylic acid, 1,4-butenedicarboxylic acid, 4-oxopyran-2,6-dicarboxylic acid, 1,6-hexanedicarboxylic acid, decanedicarboxylic acid, 1,8-heptadecanedicarboxylic acid, 1,9-heptadecanedicarboxylic acid, heptadecanedicarboxylic acid, acetylenedicarboxylic acid, 1,2-benzenedicarboxylic acid, 1,3-benzenedicarboxylic acid, 2,3-pyridinedicarboxylic acid, pyridine-2,3-dicarboxylic acid, 1,3-butadiene-1,4-dicarboxylic acid, 1,4-benzenedicarboxylic acid, p-benzenedicarboxylic acid, imidazole-2,4-dicarboxylic acid, 2-methylquinoline-3,4-dicarboxylic acid, quinoline-2,4-dicarboxylic acid, quinoxaline-2,3-dicarboxylic acid, 6-chloroquinoxaline-2,3-dicarboxylic acid, 4,4′-diaminophenylmethane-3,3′-dicarboxylic acid, quinoline-3,4-dicarboxylic acid, 7-chloro-4-hydroxyquinoline-2,8-dicarboxylic acid, diimidedicarboxylic acid, pyridine-2,6-dicarboxylic acid, 2-methylimidazole-4,5-dicarboxylic acid, thiophene-3,4-dicarboxylic acid, 2-isopropylimidazole-4,5-dicarboxylic acid, tetrahydropyran-4,4-dicarboxylic acid, perylene-3,9-dicarboxylic acid, perylenedicarboxylic acid, Pluriol E 200-dicarboxylic acid, 3,6-dioxaoctanedicarboxylic acid, 3,5-cyclohexadiene-1,2-dicarboxylic acid, octanedicarboxylic acid, pentane-3,3-carboxylic acid, 4,4′-diamino-1,1′-biphenyl-3,3′-dicarboxylic acid, 4,4′-diaminobiphenyl-3,3′-dicarboxylic acid, benzidine-3,3′-dicarboxylic acid, 1,4-bis(phenylamino)benzene-2,5-dicarboxylic acid, 1,1′-binaphthyldicarboxylic acid, 7-chloro-8-methylquinoline-2,3-dicarboxylic acid, 1-anilinoanthraquinone-2,4′-dicarboxylic acid, polytetrahydrofuran 250-dicarboxylic acid, 1,4-bis(carboxymethyl)piperazine-2,3-dicarboxylic acid, 7-chloroquinoline-3,8-dicarboxylic acid, 1-(4-carboxy)phenyl-3-(4-chloro)phenylpyrazoline-4,5-dicarboxylic acid, 1,4,5,6,7,7-hexachloro-5-norbornene-2,3-dicarboxylic acid, phenylindanedicarboxylic acid, 1,3-dibenzyl-2-oxoimidazolidine-4,5-dicarboxylic acid, 1,4-cyclohexanedicarboxylic acid, naphthalene-1,8-dicarboxylic acid, 2-benzoylbenzene-1,3-dicarboxylic acid, 1,3-dibenzyl-2-oxoimidazolidine-4,5-cis-dicarboxylic acid, 2,2′-biquinoline-4,4′-dicarboxylic acid, pyridine-3,4-dicarboxylic acid, 3,6,9-trioxaundecanedicarboxylic acid, hydroxybenzophenonedicarboxylic acid, Pluriol E 300-dicarboxylic acid, Pluriol E 400-dicarboxylic acid, Pluriol E 600-dicarboxylic acid, pyrazole-3,4-dicarboxylic acid, 2,3-pyrazinedicarboxylic acid, 5,6-dimethyl-2,3-pyrazinedicarboxylic acid, bis(4-aminophenyl) ether diimide-dicarboxylic acid, 4,4′-diaminodiphenylmethane diimide-dicarboxylic acid, bis(4-aminophenyl) sulfone diimide-dicarboxylic acid, 1,4-naphthalenedicarboxylic acid, 2,6-naphthalenedicarboxylic acid, 1,3-adamantanedicarboxylic acid, 1,8-naphthalenedicarboxylic acid, 2,3-naphthalenedicarboxylic acid, 8-methoxy-2,3-naphthalenedicarboxylic acid, 8-nitro-2,3-naphthalenecarboxylic acid, 8-sulfo-2,3-naphthalenedicarboxylic acid, anthracene-2,3-dicarboxylic acid, 2′,3′-diphenyl-p-terphenyl-4,4″-dicarboxylic acid, (diphenyl ether)-4,4′-dicarboxylic acid, imidazole-4,5-dicarboxylic acid, 4(1H)-oxothiochromene-2,8-dicarboxylic acid, 5-tert-butyl-1,3-benzenedicarboxylic acid, 7,8-quinolinedicarboxylic acid, 4,5-imidazoledicarboxylic acid, 4-cyclohexene-1,2-dicarboxylic acid, hexatriacontanedicarboxylic acid, tetradecanedicarboxylic acid, 1,7-heptanedicarboxylic acid, 5-hydroxy-1,3-benzenedicarboxylic acid, 2,5-dihydroxy-1,4-benzenedicarboxylic acid, pyrazine-2,3-dicarboxylic acid, furan-2,5-dicarboxylic acid, 1-nonene-6,9-dicarboxylic acid, eicosenedicarboxylic acid, 4,4′-dihydroxy-diphenylmethane-3,3′-dicarboxylic acid, 1-amino-4-methyl-9,10-dioxo-9,10-dihydroanthracene-2,3-dicarboxylic acid, 2,5-pyridinedicarboxylic acid, cyclohexene-2,3-dicarboxylic acid, 2,9-dichlorofluorubin-4,11-dicarboxylic acid, 7-chloro-3-methylquinoline-6,8-dicarboxylic acid, 2,4-dichlorobenzophenone-2′,5′-dicarboxylic acid, 1,3-benzenedicarboxylic acid, 2,6-pyridinedicarboxylic acid, 1-methylpyrrol-3,4-dicarboxylic acid, 1-benzyl-1H-pyrrol-3,4-dicarboxylic acid, anthraquinone-1,5-dicarboxylic acid, 3,5-pyrazoledicarboxylic acid, 2-nitrobenzene-1,4-dicarboxylic acid, heptane-1,7-dicarboxylic acid, cyclobutane-1,1-dicarboxylic acid, 1,14-tetradecanedicarboxylic acid, 5,6-dehydronorbornane-2,3-dicarboxylic acid, 5-ethyl-2,3-pyridinedicarboxylic acid, and camphordicarboxylic acid.

Further in the case where the process further comprises (a), (b), and optionally (c), it is preferred that the one or more sources of one or more organic ligands comprises, preferably consists of, a tricarboxylic acid, preferably one or more of 2-Hydroxy-1,2,3-propanetricarboxylic acid, 7-chloro-2,3,8-quinolinetricarboxylic acid, 1,2,3-benzenetricarboxylic acid, 1,2,4-benzenetricarboxylic acid, 1,2,4-butanetricarboxylic acid, 2-phosphono-1,2,4-butanetricarboxylic acid, 1,3,5-benzenetricarboxylic acid, 1-hydroxy-1,2,3-propanetricarboxylic acid, 4,5-dihydroxy-4,5-dioxo-1H-pyrrolo[2,3-f]quinoline-2,7,9-tricarboxylic acid, 5-acetyl-3-amino-6-methylbenzene-1,2,4-tricarboxylic acid, 3-amino-5-benzoyl-6-methylbenzene-1,2,4-tricarboxylic acid, 1,2,3-propanetricarboxylic acid, and aurintricarboxylic acid.

Further in the case where the process further comprises (a), (b), and optionally (c), it is preferred that the one or more sources of one or more organic ligands comprises, preferably consists of, a tetracarboxylic acid, preferably one or more of 1,1-Dioxidoperylo[1,12-BCD]thiophene-3,4,9,10-tetracarboxylic acid, a perylenetetracarboxylic acid, preferably perylene-3,4,9,10-tetracarboxylic acid or (perylene-1,12-sulfone)-3,4,9,10-tetracarboxylic acid, a butanetetracarboxylic acid, preferably 1,2,3,4-butanetetracarboxylic acid or meso-1,2,3,4-butanetetracarboxylic acid, decane-2,4,6,8-tetracarboxylic acid, 1,4,7,10,13,16-hexaoxacyclooctadecane-2,3,11,12-tetracarboxylic acid, 1,2,4,5-benzenetetracarboxylic acid, 1,2,11,12-dodecanetetracarboxylic acid, 1,2,5,6-hexanetetracarboxylic acid, 1,2,7,8-octanetetracarboxylic acid, 1,4,5,8-naphthalenetetracarboxylic acid, 1,2,9,10-decanetetracarboxylic acid, benzophenonetetracarboxylic acid, 3,3′,4,4′-benzophenonetetracarboxylic acid, tetrahydrofurantetracarboxylic acid, and a cyclopentanetetracarboxylic acid, preferably cyclopentane-1,2,3,4-tetracarboxylic acid.

Further in the case where the process further comprises (a), (b), and optionally (c), it is preferred that the one or more sources of one or more organic ligands comprises, preferably consists of, one or more of acetylenedicarboxylic acid (ADC), camphordicarboxylic acid, fumaric acid, succinic acid, a benzenedicarboxylic acid, an naphthalenedicarboxylic acid, a biphenyldicarboxylic acid, preferably 4,4′-biphenyldicarboxylic acid (BPDC), a pyrazinedicarboxylic acid, preferably 2,5-pyrazinedicarboxylic acid, a bipyridinedicarboxylic acid, preferably a 2,2′-bipyridinedicarboxylic acid, more preferably 2,2′-bipyridine-5,5′-dicarboxylic acid, a benzenetricarboxylic acid, preferably one or more of 1,2,3-benzenetricarboxylic acid, 1,2,4-benzenetricarboxylic acid, and 1,3,5-benzenetricarboxylic acid (BTC), benzenetetracarboxylic acid, adamantanetetracarboxylic acid (ATC), adamantanedibenzoate (ADB), benzenetribenzoate (BTB), methanetetrabenzoate (MTB), adamantanetetrabenzoate, and a dihydroxyterephthalic acid, preferably 2,5-dihydroxyterephthalic acid (DHBDC).

Further in the case where the process further comprises (a), (b), and optionally (c), it is preferred that the one or more sources of one or more organic ligands comprises, preferably consists of, one or more of phthalic acid, isophthalic acid, terephthalic acid, 2,6-naphthalenedicarboxylic acid, 1,4-naphthalenedicarboxylic acid, 1,5-naphthalenedicarboxylic acid, 1,2,3-benzenetricarboxylic acid, 1,2,4-benzenetricarboxylic acid, 1,3,5-benzenetricarboxylic acid, and 1,2,4,5-benzenetetracarboxylic acid.

Further in the case where the process further comprises (a), (b), and optionally (c), it is preferred that the solvent system comprises an organic compound or an inorganic compound.

Further in the case where the process further comprises (a), (b), and optionally (c), it is preferred that the solvent system comprises water, more preferably deionized water.

Further in the case where the process further comprises (a), (b), and optionally (c), it is preferred that the solvent system comprises water in an amount of 50 to 100 weight-%, based on the total weight of the solvent system, preferably of 60 to 99 weight-%, more preferably of 70 to 95 weight-%, more preferably of 80 to 90 weight-%.

Further in the case where the process further comprises (a), (b), and optionally (c), it is preferred that the solvent system comprises one or more of a C1-C6 alcohol, dimethyl sulfoxide (DMSO), N,N-dimethylformamide (DMF), N,N-diethylformamide (DEF), N,N-dimethylacetamide (DMAc), acetonitrile, toluene, 1,4-dioxane, benzene, chlorobenzene, butanone, pyridine, tetrahydrofuran (THF), ethyl acetate, an optionally halogenated C1-C200 alkane, sulfolane, diol, N-methyl-2-pyrrolidone (NMP), gamma-butyrolactone, an alicyclic alcohol, preferably cyclohexanol, a ketone, preferably acetone or acetylacetone, a cycloketone, preferably cyclohexanone, and sulfolene.

In the case where the solvent system comprises one or more of a C1-C6 alcohol, dimethyl sulfoxide (DMSO), N,N-dimethylformamide (DMF), N,N-diethylformamide (DEF), N,N-dimethylacetamide (DMAc), acetonitrile, toluene, 1,4-dioxane, benzene, chlorobenzene, butanone, pyridine, tetrahydrofuran (THF), ethyl acetate, an optionally halogenated C1-C200 alkane, sulfolane, diol, N-methyl-2-pyrrolidone (NMP), gamma-butyrolactone, an alicyclic alcohol, preferably cyclohexanol, a ketone, preferably acetone or acetylacetone, a cycloketone, preferably cyclohexanone, and sulfolene, it is preferred that the C1-C6 alcohol comprises one or more of methanol, ethanol, n-propanol, i-propanol, n-butanol, i-butanol, t-butanol, pentanol, hexanol.

Further in the case where the process further comprises (a), (b), and optionally (c), it is preferred that a molar ratio of M of the one or more sources of one or more metal ions M, calculated as element, to the organic ligand of the one or more sources of one or more organic ligands, is in the range of from 0.3:1 to 1.7:1, more preferably in the range of from 0.66:1 to 1.5:1, more preferably in the range of from 0.7:1 to 1.2:1, more preferably in the range of from 0.9:1 to 1.1:1.

Further in the case where the process further comprises (a), (b), and optionally (c), it is preferred that the solvent system comprises an amount in the range of from 0 to 10 weight-% of water, more preferably in the range of from 0.001 to 5 weight-%, more preferably in the range of from 0.01 to 1 weight-%, based on the total weight of the solvent system, wherein the solvent system more preferably is essentially free of water.

Further in the case where the process further comprises (a), (b), and optionally (c), it is preferred that preparing the mixture in (a) comprises stirring.

Further in the case where the process further comprises (a), (b), and optionally (c), it is preferred that the reaction conditions in (b) comprise solvothermal conditions.

Further in the case where the process further comprises (a), (b), and optionally (c), it is preferred that the temperature of the gas atmosphere in (b) has a temperature in the range of from 20 to 200° C., more preferably of from 100 to 170° C., more preferably of from 120 to 150° C.

Further in the case where the process further comprises (a), (b), and optionally (c), it is preferred that the gas atmosphere in (b) comprises, preferably consists of, one or more of nitrogen, oxygen, argon, and air.

Further in the case where the process further comprises (a), (b), and optionally (c), it is preferred that the reaction conditions comprise a pressure in the range of from 1 to 16 bar(abs), more preferably in the range of from 1.1 to 3 bar(abs), more preferably in the range of from 1.150 to 1.230 bar.

Further in the case where the process further comprises (a), (b), and optionally (c), it is preferred that the mixture prepared in (a) further comprises a base, more preferably one or more of an alkali metal hydroxide, an amine, and an alkali metal carbonate, more preferably one or more of sodium hydroxide, potassium hydroxide, sodium carbonate sodium hydrogen carbonate.

In the case where the mixture prepared in (a) further comprises a base, it is preferred that a molar ratio of organic compound to base is in the range of from 0.25 to 0.67, preferably in the range of from 0.25 to 0.5, more preferably in the range of from 0.3 to 0.4.

Further in the case where the process further comprises (a), (b), and optionally (c), it is preferred that the process for preparing the metal-organic framework further comprises one or more of
(d) optionally washing the isolated metal-organic framework obtained from (b) or (c);
(e) optionally drying the isolated metal-organic framework obtained from (b), (c) or the washed metal-organic framework obtained from (d) in a gas atmosphere;
(f) calcining the isolated metal-organic framework obtained from (c), the dried metal-organic framework obtained from (d), or the washed metal-organic framework obtained from (e) in a gas atmosphere.

In the case where the process further comprises one or more of (d), (e), and (f), it is preferred that washing in (d) is performed with one or more of a C1-C6 alcohol, dimethyl sulfoxide (DMSO), N,N-dimethylformamide (DMF), N,N-diethylformamide (DEF), N,N-dimethylacetamide (DMAc), acetonitrile, toluene, 1,4-dioxane, benzene, chlorobenzene, butanone, pyridine, tetrahydrofuran (THF), ethyl acetate, an optionally halogenated C1-C200 alkane, sulfolane, diol, Nmethyl-2-pyrrolidone (NMP), gamma-butyrolactone, an alicyclic alcohol, preferably cyclohexanol, a ketone, preferably acetone or acetylacetone, a cycloketone, preferably cyclohexanone, and sulfolene.

Further in the case where the process further comprises one or more of (d), (e), and (f), it is preferred that drying in (e) comprises spray-drying.

Further in the case where the process further comprises one or more of (d), (e), and (f), it is preferred that the gas atmosphere in (e) has a temperature in the range of from 50 to 150° C., more preferably in the range of from 75 to 125° C.

Further in the case where the process further comprises one or more of (d), (e), and (f), it is preferred that the gas atmosphere in (e) comprises one or more of nitrogen and oxygen, wherein the gas atmosphere more preferably is air or lean air.

Further in the case where the process further comprises one or more of (d), (e), and (f), it is preferred that the gas atmosphere in (f) has a temperature in the range of from 150 to 500° C., more preferably in the range of from 250 to 450° C., more preferably in the range of from 300 to 400° C.

Further in the case where the process further comprises one or more of (d), (e), and (f), it is preferred that the gas atmosphere in (f) comprises one or more of nitrogen and oxygen, wherein the gas atmosphere more preferably is air or lean air.

Yet further, the present invention relates to a molding comprising a polyester and a metal-organic framework, wherein the molding is obtainable and/or obtained by the process according to any one of the embodiments disclosed herein.

Yet further, the present invention relates to a use of a molding according to any one of the embodiments disclosed herein, as packaging, preferably as packaging for one or more of a food, a cosmetic, and a pharmaceutical, more preferably as packaging for one or more of skin cream, hair-care products, dental care products, medicaments, coffee, convenience food, meat, jam, a milk product, as a component for kitchen devices, preferably as a component being in contact with drinking water, or as a component for a car, preferably as a component for the interior of a motor-vehicle.

Yet further, the present invention relates to a use of a molding according to any one of the embodiments disclosed herein, for the preparation of a fiber, a film, or a molding having a shape different from the molding according to any one of the embodiments disclosed herein, preferably for the preparation of a capsule.

According to the present invention, metal-organic frameworks (also abbreviated as MOFs) are a class of compounds consisting of metal ions, which may also form clusters, coordinated to organic ligands to form one-, two-, or three-dimensional structures. According to the present invention, an organic ligand can also be understood as organic linker, both terms are equally found in the prior art.

According to the present invention, a metal-organic framework can be understood as a material with pores, in particular with pores of uniform size. Typically, the pores have diameters similar to the size of small molecules. The existence of pores is the main difference between such porous materials and other common solids. The features and structure of the pores usually determine the ways in which porous materials can be used. Depending on said features and structure, the pores can be filled with one or more fluids in liquid or gaseous state. Thus, larger molecules cannot enter or be adsorbed, while smaller molecules can. It is recommended according to a panel of the IUPAC to designate materials having a pore diameter of less than 2 nm (20 Å) as microporous, materials having a pore diameter of greater than 50 nm (500 Å) as macroporous, and materials having a pore diameter between 2 and 50 nm (20-500 Å) as mesoporous.

Numerous processes have been developed for preparing metal-organic frameworks. Typically, a metal salt is reacted with an at least bidentate organic compound, for example a dicarboxylic acid, in a suitable solvent under superatmospheric pressure and elevated temperature.

According to the present invention, an impact-modifier can be a polymer, preferably a rubber or an elastomer.

In particular with respect to the preparation of further components to be used for the preparation of the molding of the present invention reference is made to EP 3004242 B1 disclosing suitable further components. Thus, EP 3004242 B1 is incorporated herein in its entirety.

In particular with respect to the additives comprised in the molding of the present invention, reference is made to US 2003/195296 A1 disclosing suitable additives. Thus, US 2003/195296 A1 is incorporated herein in its entirety.

The unit bar(abs) refers to an absolute pressure wherein 1 bar equals 105 Pa and the unit Angstrom (A) refers to a length of 10⁻¹⁰ m.

The present invention is further illustrated by the following set of embodiments and combinations of embodiments resulting from the dependencies and back-references as indicated. In particular, it is noted that in each instance where a range of embodiments is mentioned, for example in the context of a term such as “any one of embodiments (1) to (4)”, every embodiment in this range is meant to be explicitly disclosed for the skilled person, i.e. the wording of this term is to be understood by the skilled person as being synonymous to “any one of embodiments (1), (2), (3), and (4)”. Further, it is explicitly noted that the following set of embodiments is not the set of claims determining the extent of protection, but represents a suitably structured part of the description directed to general and preferred aspects of the present invention.

According to an embodiment (1), the present invention relates to a molding comprising,
(i) a polyester in an amount in the range of from 25 to 99.99 weight-%, based on the total weight of the molding,
(ii) a metal-organic framework in an amount of from 0.01 to 25 weight-%, based on the total weight of the molding,
   wherein the metal-organic framework comprises one or more metal ions M and one or more organic ligands.

A preferred embodiment (2) concretizing embodiment (1) relates to said molding, wherein the one or more metal ions M are selected from groups 2, 11, 12, 13 of the periodic system of elements, and combinations of two or more thereof, wherein the one or more metal ions M are preferably selected from the group consisting of Al, Ga, Cu, Ag, Zn, Mg, Mn, Ti, Fe, and combinations of two or more thereof, wherein the one or more metal ions M more preferably are one or more of Al and Zn, wherein the one or more metal ions M more preferably are Al, wherein the one or more metal ions M preferably are positively charged.

A further preferred embodiment (3) concretizing embodiment (1) or (2) relates to said molding, wherein the metal-organic framework comprises the one or more metal ions M in an amount in the range of from 10 to 25 weight-%, preferably in the range of from 15 to 20 weight-%, more preferably in the range of from 16.0 to 17.6 weight-%, more preferably in the range of from 16.2 to 17.2 weight-%, more preferably in the range of from 16.4 to 17.0 weight-%, based on the total weight of the metal-organic framework.

A further preferred embodiment (4) concretizing any one of embodiments (1) to (3) relates to said molding, wherein the one or more organic ligands are coordinated to the one or more metal ions M, preferably as a bidentate ligand of the one or more metal ions M.

A further preferred embodiment (5) concretizing any one of embodiments (1) to (4) relates to said molding, wherein the one or more organic ligands are preferably an anion, more preferably one or more of a monoanion, a dianion, a trianion, and a tetraanion, more preferably one or more of dicarboxylates, tricarboxylates, and tetracarboxylates.

A further preferred embodiment (6) concretizing any one of embodiments (1) to (5) relates to said molding, wherein the one or more organic ligands comprise, preferably consist of, one or more of oxalate, succinate, tartrate, 1,4-butanedicarboxylate, 1,4-butenedicarboxylate, 4-oxopyran-2,6-dicarboxylate, 1,6-hexanedicarboxylate, decanedicarboxylate, 1,8-heptadecanedicarboxylate, 1,9-heptadecanedicarboxylate, heptadecanedicarboxylate, acetylenedicarboxylate, 1,2-benzenedicarboxylate, 1,3-benzenedicarboxylate, 2,3-pyridinedicarboxylate, pyridine-2,3-dicarboxylate, 1,3-butadiene-1,4-dicarboxylate, 1,4-benzenedicarboxylate, p-benzenedicarboxylate, imidazole-2,4-dicarboxylate, 2-methylquinoline-3,4-dicarboxylate, quinoline-2,4-dicarboxylate, quinoxaline-2,3-dicarboxylate, 6-chloroquinoxaline-2,3-dicarboxylate, 4,4′-diaminophenylmethane-3,3′-dicarboxylate, quinoline-3,4-dicarboxylate, 7-chloro-4-hydroxyquinoline-2,8-dicarboxylate, diimidedicarboxylate, pyridine-2,6-dicarboxylate, 2-methylimidazole-4,5-dicarboxylate, thiophene-3,4-dicarboxylate, 2-isopropylimidazole-4,5-dicarboxylate, tetrahydropyran-4,4-dicarboxylate, perylene-3,9-dicarboxylate, perylenedicarboxylate, Pluriol E 200-dicarboxylate, 3,6-dioxaoctanedicarboxylate, 3,5-cyclohexadiene-1,2-dicarboxylate, octanedicarboxylate, pentane-3,3-carboxylate, 4,4′-diamino-1,1′-biphenyl-3,3′-dicarboxylate, 4,4′-diaminobiphenyl-3,3′-dicarboxylate, benzidine-3,3′-dicarboxylate, 1,4-bis(phenylamino)benzene-2,5-dicarboxylate, 1,1′-binaphthyldicarboxylate, 7-chloro-8-methylquinoline-2,3-dicarboxylate, 1-anilinoanthraquinone-2,4′-dicarboxylate, polytetrahydrofuran 250-dicarboxylate, 1,4-bis(carboxymethyl)piperazine-2,3-dicarboxylate, 7-chloroquinoline-3,8-dicarboxylate, 1-(4-carboxy)phenyl-3-(4-chloro)phenylpyrazoline-4,5-dicarboxylate, 1,4,5,6,7,7-hexachloro-5-norbornene-2,3-dicarboxylate, phenylindanedicarboxylate, 1,3-dibenzyl-2-oxoimidazolidine-4,5-dicarboxylate, 1,4-cyclohexanedicarboxylate, naphthalene-1,8-dicarboxylate, 2-benzoylbenzene-1,3-dicarboxylate, 1,3-dibenzyl-2-oxoimidazolidine-4,5-cis-dicarboxylate, 2,2′-biquinoline-4,4′-dicarboxylate, pyridine-3,4-dicarboxylate, 3,6,9-trioxaundecanedicarboxylate, hydroxybenzophenonedicarboxylate, Pluriol E 300-dicarboxylate, Pluriol E 400-dicarboxylate, Pluriol E 600-dicarboxylate, pyrazole-3,4-dicarboxylate, 2,3-pyrazinedicarboxylate, 5,6-dimethyl-2,3-pyrazinedicarboxylate, bis(4-aminophenyl) ether diimide-dicarboxylate, 4,4′-diaminodiphenylmethane diimide-dicarboxylate, bis(4-aminophenyl) sulfone diimide-dicarboxylate, 1,4-naphthalenedicarboxylate, 2,6-naphthalene-dicarboxylate, 1,3-adamantanedicarboxylate, 1,8-naphthalenedicarboxylate, 2,3-naphthalenedicarboxylate, 8-methoxy-2,3-naphthalenedicarboxylate, 8-nitro-2,3-naphthalenecarboxylate, 8-sulfo-2,3-naphthalenedicarboxylate, anthracene-2,3-dicarboxylate, 2′,3′-diphenyl-p-terphenyl-4,4″-dicarboxylate, (diphenyl ether)-4,4′-dicarboxylate, imidazole-4,5-dicarboxylate, 4(1H)-oxothiochromene-2,8-dicarboxylate, 5-tert-butyl-1,3-benzenedicarboxylate, 7,8-quinolinedicarboxylate, 4,5-imidazoledicarboxylate, 4-cyclohexene-1,2-dicarboxylate, hexatriacontanedicarboxylate, tetradecanedicarboxylate, 1,7-heptanedicarboxylate, 5-hydroxy-1,3-benzenedicarboxylate, 2,5-dihydroxy-1,4-benzenedicarboxylate, pyrazine-2,3-dicarboxylate, furan-2,5-dicarboxylate, 1-nonene-6,9-dicarboxylate, eicosenedicarboxylate, 4,4′-dihydroxy-diphenylmethane-3,3′-dicarboxylate, 1-amino-4-methyl-9,10-dioxo-9,10-dihydroanthracene-2,3-dicarboxylate, 2,5-pyridinedicarboxylate, cyclohexene-2,3-dicarboxylate, 2,9-dichlorofluorubin-4,11-dicarboxylate, 7-chloro-3-methylquinoline-6,8-dicarboxylate, 2,4-dichlorobenzophenone-2′,5′-dicarboxylate, 1,3-benzenedicarboxylate, 2,6-pyridinedicarboxylate, 1-methylpyrrol-3,4-dicarboxylate, 1-benzyl-1H-pyrrol-3,4-dicarboxylate, anthraquinone-1,5-dicarboxylate, 3,5-pyrazoledicarboxylate, 2-nitrobenzene-1,4-dicarboxylate, heptane-1,7-dicarboxylate, cyclobutane-1,1-dicarboxylate, 1,14-tetradecanedicarboxylate, 5,6-dehydronorbornane-2,3-dicarboxylate, 5-ethyl-2,3-pyridinedicarboxylate, and camphordicarboxylate.

A further preferred embodiment (7) concretizing any one of embodiments (1) to (5) relates to said molding, wherein the one or more organic ligands comprise, preferably consist of, one or more of 2-Hydroxy-1,2,3-propanetricarboxylate, 7-chloro-2,3,8-quinolinetricarboxylate, 1,2,3-benzenetricarboxylate, 1,2,4-benzenetricarboxylate, 1,2,4-butanetricarboxylate, 2-phosphono-1,2,4-butanetricarboxylate, 1,3,5-benzenetricarboxylate, 1-hydroxy-1,2,3-propanetricarboxylate, 4,5-dihydroxy-4,5-dioxo-1H-pyrrolo[2,3-f]quinoline-2,7,9-tricarboxylate, 5-acetyl-3-amino-6-methylbenzene-1,2,4-tricarboxylate, 3-amino-5-benzoyl-6-methylbenzene-1,2,4-tricarboxylate, 1,2,3-propanetricarboxylate, and aurintricarboxylate.

A further preferred embodiment (8) concretizing any one of embodiments (1) to (5) relates to said molding, wherein the one or more organic ligands comprise, preferably consist of, one or more of 1,1-Dioxidoperylo[1,12-BCD]thiophene-3,4,9,10-tetracarboxylate, a perylenetetracarboxylate, preferably perylene-3,4,9,10-tetracarboxylate or (perylene-1,12-sulfone)-3,4,9,10-tetracarboxylate, a butanetetracarboxylate, preferably 1,2,3,4-butanetetracarboxylate or meso-1,2,3,4-butanetetracarboxylate, decane-2,4,6,8-tetracarboxylate, 1,4,7,10,13,16-hexaoxacyclooctadecane-2,3,11,12-tetracarboxylate, 1,2,4,5-benzenetetracarboxylate, 1,2,11,12-dodecanetetracarboxylate, 1,2,5,6-hexanetetracarboxylate, 1,2,7,8-octanetetracarboxylate, 1,4,5,8-naphthalenetetracarboxylate, 1,2,9,10-decanetetracarboxylate, benzophenonetetracarboxylate, 3,3′,4,4′-benzophenonetetracarboxylate, tetrahydrofurantetracarboxylate, and a cyclopentanetetracarboxylate, preferably cyclopentane-1,2,3,4-tetracarboxylate.

A further preferred embodiment (9) concretizing any one of embodiments (1) to (5) relates to said molding, wherein the one or more organic ligands comprise, preferably consist of, one or more of acetylenedicarboxylate (ADC), camphordicarboxylate, fumarate, succinate, a benzenedicarboxylate, an naphthalenedicarboxylate, a biphenyldicarboxylate, preferably 4,4′-biphenyldicarboxylate (BPDC), a pyrazinedicarboxylate, preferably 2,5-pyrazinedicarboxylate, a bipyridinedicarboxylate, preferably a 2,2′-bipyridinedicarboxylate, more preferably 2,2′-bipyridine-5,5′-dicarboxylate, a benzenetricarboxylate, preferably one or more of 1,2,3-benzenetricarboxylate, 1,2,4-benzenetricarboxylate, and 1,3,5-benzenetricarboxylate (BTC), benzenetetracarboxylate, adamantanetetracarboxylate (ATC), adamantanedibenzoate (ADB), benzenetribenzoate (BTB), methanetetrabenzoate (MTB), adamantanetetrabenzoate, and a dihydroxyterephthalate, preferably 2,5-dihydroxyterephthalate (DHBDC).

A further preferred embodiment (10) concretizing any one of embodiments (1) to (5) relates to said molding, wherein the one or more organic ligands comprise, preferably consist of, one or more of phthalate, isophthalate, terephthalate, 2,6-naphthalenedicarboxylate, 1,4-naphthalenedicarboxylate, 1,5-naphthalenedicarboxylate, 1,2,3-benzenetricarboxylate, 1,2,4-benzenetricarboxylate, 1,3,5-benzenetricarboxylate, and 1,2,4,5-benzenetetracarboxylate.

A further preferred embodiment (11) concretizing any one of embodiments (1) to (10) relates to said molding, wherein from 99 to 100 weight-%, preferably from 99.5 to 100, more preferably from 99.9 to 100 weight-%, of the metal-organic framework consists of the one or more metal ions M and the one or more organic ligands.

A further preferred embodiment (12) concretizing any one of embodiments (1) to (11) relates to said molding, wherein the metal-organic framework comprises M, C, O, and H.

A further preferred embodiment (13) concretizing embodiment (12) relates to said molding, wherein from 95 to 100 weight-%, preferably from 97 to 100 weight-%, more preferably from 99 to 100 weight-% of the metal-organic framework consists of M, C, O, and H, wherein more preferably from 95 to 100 weight-%, more preferably from 97 to 100 weight-%, more preferably from 99 to 100 weight-% of the metal-organic framework consists of M, C, O, and H.

A further preferred embodiment (14) concretizing any one of embodiments (1) to (13) relates to said molding, wherein the metal-organic framework is microporous, wherein the metal-organic framework preferably comprises one or more pores formed by one or more one-dimensional channels having a diameter in the range of from 5 to 15 Angstrom, more preferably in the range of from 7 to 12 Angstrom.

A further preferred embodiment (15) concretizing any one of embodiments (1) to (14) relates to said molding, wherein the metal-organic framework shows an orthorhombic crystal system, preferably determined according to Reference Example 1.

A further preferred embodiment (16) concretizing any one of embodiments (1) to (15) relates to said molding, wherein the metal-organic framework shows an x-ray diffraction pattern comprising a peak having a maximum in the range of from 8° to 12° 2theta, preferably determined according to Reference Example 1.

A further preferred embodiment (17) concretizing any one of embodiments (1) to (16) relates to said molding, wherein the metal-organic framework shows an x-ray diffraction pattern comprising at least the following peaks:

| Intensity (%) | Diffraction angle 2θ/° [Cu K(alpha 1)] |
|---|---|
| 100 | 9.5-11.5 |
| 6-12 | 13-17 |
| 19-24 | 20-22 |
| 16-21 | 31-33 |
| 9-15 | 42-43.5 |

wherein 100% relates to the intensity of the maximum peak in the x-ray powder diffraction pattern, wherein the x-ray diffraction pattern is preferably determined according to Reference Example 1.

A further preferred embodiment (18) concretizing any one of embodiments (1) to (17) relates to said molding, wherein the metal-organic framework shows in the temperature programmed desorption of ammonia in the temperature range of from 100 to 500° C. an ammonia adsorption of equal to or smaller than 2.0 mmol/g, preferably of equal to or smaller than 1.9 mmol/g, more preferably in the range of from 0.1 to 1.8 mmol/g, more preferably in the range of from 0.5 to 1.7 mmol/g, more preferably in the range of from 1.0 to 1.6 mmol/g, preferably determined according to Reference Example 4.

A further preferred embodiment (19) concretizing any one of embodiments (1) to (18) relates to said molding, wherein the metal-organic framework shows in the temperature programmed desorption of ammonia in the temperature range of from 100 to 500° C. a first peak having a maximum in the range of from 100 to 300° C., preferably in the range of from 180 to 250° C., more preferably in the range of from 210 to 220° C., preferably determined according to Reference Example 4.

A further preferred embodiment (20) concretizing any one of embodiments (1) to (19) relates to said molding, wherein the metal-organic framework shows in the temperature programmed desorption of ammonia in the temperature range of from greater than 100 to 500° C. a second peak having a maximum in the range of from 225 to 400° C., preferably in the range of from 280 to 360° C., more preferably in the range of from 310 to 325° C., preferably determined according to Reference Example 4.

A further preferred embodiment (21) concretizing any one of embodiments (1) to (20) relates to said molding, wherein the molding comprises the metal-organic framework in an amount in the range of from 0.5 to 20.0 weight-%, more preferably in the range of from 0.75 to 10.0 weight-%, more preferably in the range of from 1.0 to 5.0 weight-%, more preferably in the range of from 1.25 to 3.5 weight-%, more preferably in the range of from 1.5 to 3.0 weight-%, more preferably in the range of from 1.7 to 2.5 weight-%, more preferably in the range of from 1.8 to 2.2 weight-%, based on the total weight of the molding.

A further preferred embodiment (22) concretizing any one of embodiments (1) to (21) relates to said molding, wherein the metal-organic framework shows a water adsorption in the range of from 0.1 to 70 weight-% when exposed to a relative humidity of 85%, preferably in the range of from 0.25 to 60 weight-%, more preferably in the range of from 25.0 to 55.0 weight-%, more preferably in the range of from 35.0 to 52.0 weight-%, and more preferably in the range of from 45.0 to 50.0 weight-%, wherein the water adsorption is preferably determined according to Reference Example 3.

A further preferred embodiment (23) concretizing any one of embodiments (1) to (22) relates to said molding, wherein the metal-organic framework has a Langmuir specific surface area of at least 1000 m²/g, preferably of at least 1200 m²/g, more preferably in the range of from 1200 to 600 m²/g, preferably determined according to Reference Example 2.

A further preferred embodiment (24) concretizing any one of embodiments (1) to (23) relates to said molding, wherein the metal-organic framework shows in the temperature programmed desorption of water a type IV isotherm, preferably determined according to Reference Example 3.

A further preferred embodiment (25) concretizing any one of embodiments (1) to (24) relates to said molding, wherein the molding comprises the polyester in an amount in the range of from 30 to 99.0 weight-%, more preferably in the range of from 32.5 to 97.5 weight-%, more preferably in the range of from 32.5 to 95 weight-%, more preferably in the range of from 35 to 85 weight-%, based on the total weight of the molding.

A further preferred embodiment (26) concretizing any one of embodiments (1) to (25) relates to said molding, wherein the polyester preferably comprises a butanediol ester, preferably a monoester or a diester, more preferably a 1,4-butanediol ester.

A further preferred embodiment (27) concretizing any one of embodiments (1) to (26) relates to said molding, wherein the polyester comprises, preferably consists of, a poly(alkylene dicarboxylate) polyester, wherein the dicarboxylate of the poly(alkylene dicarboxylate) polyester comprises, preferably consists of, one or more of adipate, terephthalate, sebacate, azelate, succinate, and 2,5-furandicarboxylate, preferably one or more of adipate and terephthalate, more preferably adipate terephthalate or terephthalate, wherein the alkylene preferably comprises, more preferably consists of, one or more of ethylene, propylene, and butylene.

A further preferred embodiment (28) concretizing any one of embodiments (1) to (27) relates to said molding, wherein the polyester comprises one or more poly(alkylene) terephthalates, wherein the alkylene preferably comprises from 2 to 10, preferably from 3 to 5 carbon atoms, wherein the alkylene more preferably is butylene, wherein the polyester comprises more preferably one or more of a poly(ethylene) terephthalate, a poly(propylene) terephthalate, and a poly(butylene) terephthalate, wherein the polyester more preferably comprises, preferably consists of, one or more poly(butylene) terephthalates.

A further preferred embodiment (29) concretizing embodiment (28) relates to said molding, wherein the polyester comprises the one or more poly(alkylene) terephthalates in an amount in the range of from 30 to 100 weight-%, preferably in the range of from 50 to 100 weight-%, more preferably in the range of from 60 to 100 weight-%, based on the total weight of the polyester.

A further preferred embodiment (30) concretizing any one of embodiments (1) to (29) relates to said molding, wherein the polyester has a viscosity number in the range of from 50 to 220, preferably in the range of from 80 to 160, preferably determined according to ISO 1628-5:1998.

A further preferred embodiment (31) concretizing any one of embodiments (1) to (30) relates to said molding, wherein the polyester has a melt-volume flow-rate in the range of from 10 to 160 cm³/g 600 s, preferably in the range of from 30 to 125 cm³/g 600 s, more preferably in the range of from 40 to 115 cm³/g 600 s, preferably determined according to ISO 1133 for 250° C./2.16 kg, wherein the polyester preferably comprises, preferably consists of, a poly(butylene) terephthalate.

A further preferred embodiment (32) concretizing any one of embodiments (1) to (31) relates to said molding, wherein the polyester comprises an amount of terminal carboxy groups equal to or less than 100 meq/kg of polyester, preferably equal to or less than 50 meq/kg of polyester, more preferably equal to or less than 40 meq/kg of polyester.

A further preferred embodiment (33) concretizing any one of embodiments (1) to (32) relates to said molding, wherein the polyester comprises Ti in an amount of equal to or less than 250 ppm, preferably equal to or less than 200 ppm, more preferably equal to or less than 150 ppm.

A further preferred embodiment (34) concretizing any one of embodiments (1) to (33) relates to said molding, wherein the polyester comprises a blend of a poly(alkylene) terephthalate and a further polyester, wherein the further polyester is different to the poly(alkylene) terephthalate.

A further preferred embodiment (35) concretizing any one of embodiments (1) to (34) relates to said molding, wherein the polyester comprises a poly(alkylene) terephthalate and a fully aromatic polyester, preferably a fully aromatic polyester of an aromatic dicarboxylic acid or a fully aromatic polyester of an aromatic dihydroxy compound.

A further preferred embodiment (36) concretizing embodiment (35) relates to said molding, wherein the polyester comprises from 2 to 80 weight-% of the fully aromatic polyester.

A further preferred embodiment (37) concretizing any one of embodiments (1) to (36) relates to said molding, wherein the polyester comprises a polycarbonate, preferably a halide-free polycarbonate, more preferably a polycarbonate comprising a biphenol repeating unit.

A further preferred embodiment (38) concretizing embodiment (37) relates to said molding, wherein the polycarbonate comprises a relative viscosity nᵣₑₗ in the range of from 1.10 to 1.50, preferably in the range of from 1.25 to 1.40.

A further preferred embodiment (39) concretizing embodiment (37) or (38) relates to said molding, wherein the polycarbonate has an average molar mass M, (weight average molar mass) in the range of from 10000 to 200000 g/mol, preferably in the range of from 20000 to 80000 g/mol, preferably determined according to Reference Example 5.

A further preferred embodiment (40) concretizing any one of embodiments (1) to (39) relates to said molding, comprising an acrylic acid polymer, preferably in an amount in the range of from 0.01 to 2 weight-%, more preferably in the range of from 0.05 to 1.5 weight-%, more preferably in the range of from 0.1 to 1 weight-%, based on the total weight of the molding.

A further preferred embodiment (41) concretizing embodiment (40) relates to said molding, wherein the acrylic acid polymer comprises acrylic acid units in an amount in the range of from 70 to 100 weight-%, preferably in the range of from 85 to 100 weight-%, based on the total weight of the acrylic acid polymer, and wherein the acrylic acid polymer comprises an ethylenically unsaturated monomer different to acrylic acid, selected from the group consisting of monoethylenically unsaturated carboxylic acids, preferably in an amount in the range of from equal to or greater than 0 to 30 weight-%, more preferably in the range of from equal to or greater than 0 to 15 weight-%, wherein the monoethylenically unsaturated carboxylic acid comprises one or more of methacrylic acid, maleic acid, fumaric acid, itaconic acid, mesaconic acid, methylenemalonic acid, and citraconic acid.

A further preferred embodiment (42) concretizing embodiment (40) or (41) relates to said molding, wherein the acrylic acid polymer has an average molar mass M_{w} (weight average molar mass) in the range of from 1000 to 100,000 g/mol, preferably in the range of from 1000 to 12,000 g/mol, more preferably in the range of from 1,500 to 8,000 g/mol, more preferably in the range of from 3,500 to 6,500 g/mol, preferably determined according to Reference Example 5.

A further preferred embodiment (43) concretizing any one of embodiments (40) to (42) relates to said molding, wherein the acrylic acid polymer has a pH of equal to or less than 4, preferably of equal to or less than 3.

A further preferred embodiment (44) concretizing any one of embodiments (1) to (43) relates to said molding, wherein the molding further comprises one or more additives, wherein the additives are preferably selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, preferably from the group consisting of glass fibers, minerals, impact-modifiers, fluorine-containing ethylene polymers, and a mixture of two or more thereof.

A further preferred embodiment (45) concretizing embodiment (44) relates to said molding, wherein the stabilizers comprise one or more of alkoxymethylmelamines, amino-substituted triazines, sterically hindered phenols, metal-containing compounds, alkaline earth metal silicates, alkaline earth metal glycerophosphates, polyamides, sterically hindered amines, wherein the metal-containing compounds preferably comprise one or more of potassium hydroxide, calcium hydroxide, magnesium hydroxide, and magnesium carbonate.

A further preferred embodiment (46) concretizing embodiments (44) or (45) relates to said molding, wherein the lubricants comprise an ester of a fatty acid and a polyol, wherein the fatty acid is preferably an unsaturated fatty acid or a saturated fatty acid, wherein the saturated fatty acid is preferably selected from the group consisting of caprylic acid, capric acid, lauric acid, stearic acid, arachidic acid, behenic acid, lignoceric acid, cerotic acid, and a mixture of two or more thereof, wherein the saturated fatty acid more preferably comprises, more preferably consists of, stearic acid, wherein the unsaturated fatty acid is preferably selected from the group consisting of myristoleic acid, palmitoleic acid, sapienic acid, oleic acid, elaidic acid, vaccenic acid, linoleic acid, linoelaidic acid, alpha-linolenic acid, arachidonic acid, eicosapentaenoic acid, erucic acid, docosahexaenoic acid, and a mixture of two or more thereof, wherein the polyol is preferably selected from the group of triols, tetrols, pentols, hexols, and ammixture of two or more thereof, wherein the polyol more preferably comprises one or more of sorbitol, xylitol, erythritol, threitol, and pentaerythritol, wherein the polyol more preferably comprises, more preferably consists of, pentaerythritol.

A further preferred embodiment (47) concretizing any one of embodiments (44) to (46) relates to said molding, comprising the lubricants in an amount in the range of from 0.20 to 1.00 weight-%, preferably in the range of from 0.35 to 0.70 weight-%, more preferably in the range of from 0.39 to 0.66 weight-%, based on the total weight of the molding.

A further preferred embodiment (48) concretizing any one of embodiments (44) to (47) relates to said molding, wherein the glass fibers comprise one or more of glass wovens, glass mats, glass nonwovens, glass filament rovings, and chopped glass filaments made from low-alkali E glass, wherein the glass fibers preferably have a diameter in the range of from 5 to 200 micrometer, more preferably in the range of from 8 to 50 micrometer.

A further preferred embodiment (49) concretizing any one of embodiments (44) to (48) relates to said molding, wherein the impact-modifiers comprises one or more of an ethylene-propylene elastomer, an ethylene-propylene-diene elastomer, and an emulsion polymer.

A further preferred embodiment (50) concretizing any one of embodiments (44) to (49) relates to said molding, wherein the elastomer is homogeneously structured and has a core-shell structure, wherein the core-shell structure preferably comprises a unit of one or more of 1,3-butadiene, isoprene, n-butyl acrylate, ethylhexyl acrylate, styrene acrylonitrile, and methyl methacrylate, for the core, and wherein the core-shell structure preferably comprises a unit of one or more of styrene acrylonitrile, methyl methacrylate, n-butyl acrylate, ethyl acrylate, methyl acrylate, 1,3-butadiene, isoprene, and ethylhexyl acrylate, for the shell.

A further preferred embodiment (51) concretizing any one of embodiments (44) to (50) relates to said molding, wherein the emulsion polymer is selected from the group consisting of n-butyl acrylate-(meth)acrylic acid copolymers, n-butyl acrylateglycidyl acrylate or n-butyl acrylate-glycidyl methacrylate copolymers.

A further preferred embodiment (52) concretizing any one of embodiments (44) to (51) relates to said molding, wherein the fillers comprise one or more of carbon black, glass fibers, glass beads, amorphous silica, asbestos, calcium silicate, calcium metasilicate, magnesium carbonate, kaolin, chalk, powdered quartz, mica, barium sulfate, feldspar, aramid fibers, potassium titanate fibers, and acicular mineral fillers, preferably acicular wollastonite.

A further preferred embodiment (53) concretizing any one of embodiments (44) to (52) relates to said molding, comprising the fluorine-containing ethylene polymers, wherein the fluorine-containing ethylene polymers preferably comprise a fluorine content in the range of from 55 to 76 weight-%, more preferably in the range of from 70 to 76 weight-%, based on the total weight of the fluorine-containing ethylene polymers, wherein the fluorine-containing ethylene polymers preferably are one or more of polytetrafluoroethylene (PTFE), tetrafluoroethylene-hexafluoropropylene copolymers, and tetrafluoroethylene copolymers, wherein the molding preferably comprises the fluorine-containing ethylene polymers in an amount in the range of from equal to or greater than 0 to 2 weight-%, based on the total weight of the molding.

A further preferred embodiment (54) concretizing any one of embodiments (44) to (53) relates to said molding, wherein the molding comprises the one or more additives in an amount in the range of from equal to or greater than 0 to 70 weight-%, based on the total weight of the molding, preferably in the range of from 0.01 to 50 weight-%, more preferably in the range of from 0.1 to 30 weight-%, more preferably in the range of from 1 to 25 weight-%.

A further preferred embodiment (55) concretizing any one of embodiments (1) to (54) relates to said molding, wherein the molding is in the form of a powder, of a granule, or of an extrudate, wherein the extrudate is preferably a strand.

A further preferred embodiment (56) concretizing any one of embodiments (1) to (55) relates to said molding, wherein the molding has a total emission of volatile organic compounds of at most 50 ppm, preferably of at most 20 ppm, more preferably of at most 15 ppm, more preferably of at most 10 ppm.

An embodiment (57) of the present invention relates to a process for the preparation of a molding comprising a polyester and a metal-organic framework, preferably of a molding according to any one of embodiments (1) to (56), said process comprising
(i) Preparing a mixture comprising a polyester in an amount in the range of from 25 to 99.99 weight-%, based on the total weight of the mixture, a metal-organic framework in an amount of from 0.01 to 25 weight-%, based on the total weight of the mixture, and optionally one or more additives in an amount in the range of from equal to or greater than 0 to 70 weight-%, based on the total weight of the mixture;
(ii) Shaping the mixture obtained from (i);
   wherein the metal-organic framework comprises one or more metal ions M and one or more organic ligands.

A preferred embodiment (58) concretizing embodiment (57) relates to said process, wherein preparing the mixture according to (i) is performed in a mixer.

A preferred embodiment (58) concretizing embodiment (57) or (58) relates to said process, wherein preparing the mixture according to (i) is performed at a temperature of the mixture in the range of from 200 to 300° C., preferably in the range of from 225 to 290° C., more preferably in the range of from 230 to 280° C.

A preferred embodiment (60) concretizing any one of embodiments (57) to (59) relates to said process, wherein shaping according to (ii) comprises extruding the mixture obtained from (i), preferably with an extruder, more preferably a twin-screw-extruder.

A preferred embodiment (61) concretizing any one of embodiments (57) to (60) relates to said process, wherein the mixture is shaped in (ii) to a granule or an extrudate, wherein the mixture is preferably shaped in (ii) to a strand.

A preferred embodiment (62) concretizing any one of embodiments (57) to (61) relates to said process, wherein the one or more metal ions M are selected from groups 2, 11, 12, 13 of the periodic system of elements, and combinations of two or more thereof, wherein the one or more metal ions M preferably are selected from the group consisting of Al, Ga, Cu, Ag, Zn, Mg, Mn, Ti, Fe, and combinations of two or more thereof, wherein the one or more metal ions M more preferably are one or more of Al and Zn, wherein the one or more metal ions M more preferably are Al, wherein the one or more metal ions M are preferably positively charged.

A preferred embodiment (63) concretizing any one of embodiments (57) to (62) relates to said process, wherein the metal-organic framework comprises the one or more metal ions M in an amount in the range of from 10 to 25 weight-%, preferably in the range of from 15 to 20 weight-%, more preferably in the range of from 16.0 to 17.6 weight-%, more preferably in the range of from 16.2 to 17.2 weight-%, more preferably in the range of from 16.4 to 17.0 weight-%, based on the total weight of the metal-organic framework.

A preferred embodiment (64) concretizing any one of embodiments (57) to (63) relates to said process, wherein the one or more organic ligands of the metal-organic framework are coordinated to the one or more metal ions M, preferably as a bidentate ligand of the one or more metal ions M.

A preferred embodiment (65) concretizing any one of embodiments (57) to (64) relates to said process, wherein the one or more organic ligands of the metal-organic framework are negatively charged, wherein the one or more organic ligands preferably comprise, more preferably consist of, one or more of monoanions, dianions, trianions, and tetraanions, more preferably one or more of dicarboxylates, tricarboxylates, and tetracarboxylates.

A preferred embodiment (66) concretizing any one of embodiments (57) to (65) relates to said process, wherein the one or more organic ligands of the metal-organic framework comprise, preferably consist of, one or more of oxalate, succinate, tartrate, 1,4-butanedicarboxylate, 1,4-butenedicarboxylate, 4-oxopyran-2,6-dicarboxylate, 1,6-hexanedicarboxylate, decanedicarboxylate, 1,8-heptadecanedicarboxylate, 1,9-heptadecanedicarboxylate, heptadecanedicarboxylate, acetylenedicarboxylate, 1,2-benzenedicarboxylate, 1,3-benzenedicarboxylate, 2,3-pyridinedicarboxylate, pyridine-2,3-dicarboxylate, 1,3-butadiene-1,4-dicarboxylate, 1,4-benzenedicarboxylate, p-benzenedicarboxylate, imidazole-2,4-dicarboxylate, 2-methylquinoline-3,4-dicarboxylate, quinoline-2,4-dicarboxylate, quinoxaline-2,3-dicarboxylate, 6-chloroquinoxaline-2,3-dicarboxylate, 4,4′-diaminophenylmethane-3,3′-dicarboxylate, quinoline-3,4-dicarboxylate, 7-chloro-4-hydroxyquinoline-2,8-dicarboxylate, diimidedicarboxylate, pyridine-2,6-dicarboxylate, 2-methylimidazole-4,5-dicarboxylate, thiophene-3,4-dicarboxylate, 2-isopropylimidazole-4,5-dicarboxylate, tetrahydropyran-4,4-dicarboxylate, perylene-3,9-dicarboxylate, perylenedicarboxylate, Pluriol E 200-dicarboxylate, 3,6-dioxaoctanedicarboxylate, 3,5-cyclohexadiene-1,2-dicarboxylate, octanedicarboxylate, pentane-3,3-carboxylate, 4,4′-diamino-1,1′-biphenyl-3,3′-dicarboxylate, 4,4′-diaminobiphenyl-3,3′-dicarboxylate, benzidine-3,3′-dicarboxylate, 1,4-bis(phenylamino)benzene-2,5-dicarboxylate, 1,1′-binaphthyldicarboxylate, 7-chloro-8-methylquinoline-2,3-dicarboxylate, 1-anilinoanthraquinone-2,4′-dicarboxylate, polytetrahydrofuran 250-dicarboxylate, 1,4-bis(carboxymethyl)piperazine-2,3-dicarboxylate, 7-chloroquinoline-3,8-dicarboxylate, 1-(4-carboxy)phenyl-3-(4-chloro)phenylpyrazoline-4,5-dicarboxylate, 1,4,5,6,7,7-hexachloro-5-norbornene-2,3-dicarboxylate, phenylindanedicarboxylate, 1,3-dibenzyl-2-oxoimidazolidine-4,5-dicarboxylate, 1,4-cyclohexanedicarboxylate, naphthalene-1,8-dicarboxylate, 2-benzoylbenzene-1,3-dicarboxylate, 1,3-dibenzyl-2-oxoimidazolidine-4,5-cis-dicarboxylate, 2,2′-biquinoline-4,4′-dicarboxylate, pyridine-3,4-dicarboxylate, 3,6,9-trioxaundecanedicarboxylate, hydroxybenzophenonedicarboxylate, Pluriol E 300-dicarboxylate, Pluriol E 400-dicarboxylate, Pluriol E 600-dicarboxylate, pyrazole-3,4-dicarboxylate, 2,3-pyrazinedicarboxylate, 5,6-dimethyl-2,3-pyrazinedicarboxylate, bis(4-aminophenyl) ether diimide-dicarboxylate, 4,4′-diaminodiphenylmethane diimide-dicarboxylate, bis(4-aminophenyl) sulfone diimide-dicarboxylate, 1,4-naphthalenedicarboxylate, 2,6-naphthalene-dicarboxylate, 1,3-adamantanedicarboxylate, 1,8-naphthalenedicarboxylate, 2,3-naphthalenedicarboxylate, 8-methoxy-2,3-naphthalenedicarboxylate, 8-nitro-2,3-naphthalenecarboxylate, 8-sulfo-2,3-naphthalenedicarboxylate, anthracene-2,3-dicarboxylate, 2′,3′-diphenyl-p-terphenyl-4,4″-dicarboxylate, (diphenyl ether)-4,4′-dicarboxylate, imidazole-4,5-dicarboxylate, 4(1H)-oxothiochromene-2,8-dicarboxylate, 5-tert-butyl-1,3-benzenedicarboxylate, 7,8-quinolinedicarboxylate, 4,5-imidazoledicarboxylate, 4-cyclohexene-1,2-dicarboxylate, hexatriacontanedicarboxylate, tetradecanedicarboxylate, 1,7-heptanedicarboxylate, 5-hydroxy-1,3-benzenedicarboxylate, 2,5-dihydroxy-1,4-benzenedicarboxylate, pyrazine-2,3-dicarboxylate, furan-2,5-dicarboxylate, 1-nonene-6,9-dicarboxylate, eicosenedicarboxylate, 4,4′-dihydroxy-diphenylmethane-3,3′-dicarboxylate, 1-amino-4-methyl-9,10-dioxo-9,10-dihydroanthracene-2,3-dicarboxylate, 2,5-pyridinedicarboxylate, cyclohexene-2,3-dicarboxylate, 2,9-dichlorofluorubin-4,11-dicarboxylate, 7-chloro-3-methylquinoline-6,8-dicarboxylate, 2,4-dichlorobenzophenone-2′,5′-dicarboxylate, 1,3-benzenedicarboxylate, 2,6-pyridinedicarboxylate, 1-methylpyrrol-3,4-dicarboxylate, 1-benzyl-1H-pyrrol-3,4-dicarboxylate, anthraquinone-1,5-dicarboxylate, 3,5-pyrazoledicarboxylate, 2-nitrobenzene-1,4-dicarboxylate, heptane-1,7-dicarboxylate, cyclobutane-1,1-dicarboxylate, 1,14-tetradecanedicarboxylate, 5,6-dehydronorbornane-2,3-dicarboxylate, 5-ethyl-2,3-pyridinedicarboxylate, and camphordicarboxylate.

A preferred embodiment (67) concretizing any one of embodiments (57) to (66) relates to said process, wherein the one or more organic ligands of the metal-organic framework comprise, preferably consist of, one or more of 2-Hydroxy-1,2,3-propanetricarboxylate, 7-chloro-2,3,8-quinolinetricarboxylate, 1,2,3-benzenetricarboxylate, 1,2,4-benzenetricarboxylate, 1,2,4-butanetricarboxylate, 2-phosphono-1,2,4-butanetricarboxylate, 1,3,5-benzenetricarboxylate, 1-hydroxy-1,2,3-propanetricarboxylate, 4,5-dihydroxy-4,5-dioxo-1H-pyrrolo[2,3-f]quinoline-2,7,9-tricarboxylate, 5-acetyl-3-amino-6-methylbenzene-1,2,4-tricarboxylate, 3-amino-5-benzoyl-6-methylbenzene-1,2,4-tricarboxylate, 1,2,3-propanetricarboxylate, and aurintricarboxylate.

A preferred embodiment (68) concretizing any one of embodiments (57) to (67) relates to said process, wherein the one or more organic ligands of the metal-organic framework comprise, preferably consist of, one or more of 1,1-Dioxidoperylo[1,12-BCD]thiophene-3,4,9,10-tetracarboxylate, a perylenetetracarboxylate, preferably perylene-3,4,9,10-tetracarboxylate or (perylene-1,12-sulfone)-3,4,9,10-tetracarboxylate, a butanetetracarboxylate, preferably 1,2,3,4-butanetetracarboxylate or meso-1,2,3,4-butanetetracarboxylate, decane-2,4,6,8-tetracarboxylate, 1,4,7,10,13,16-hexaoxacyclooctadecane-2,3,11,12-tetracarboxylate, 1,2,4,5-benzenetetracarboxylate, 1,2,11,12-dodecanetetracarboxylate, 1,2,5,6-hexanetetracarboxylate, 1,2,7,8-octanetetracarboxylate, 1,4,5,8-naphthalenetetracarboxylate, 1,2,9,10-decanetetracarboxylate, benzophenonetetracarboxylate, 3,3′,4,4′-benzophenonetetracarboxylate, tetrahydrofurantetracarboxylate, and a cyclopentanetetracarboxylate, preferably cyclopentane-1,2,3,4-tetracarboxylate.

A preferred embodiment (69) concretizing any one of embodiments (57) to (68) relates to said process, wherein the one or more organic ligands of the metal-organic framework comprise, preferably consist of, one or more of acetylenedicarboxylate (ADC), camphordicarboxylate, fumarate, succinate, a benzenedicarboxylate, an naphthalenedicarboxylate, a biphenyldicarboxylate, preferably 4,4′-biphenyldicarboxylate (BPDC), a pyrazinedicarboxylate, preferably 2,5-pyrazinedicarboxylate, a bipyridinedicarboxylate, preferably a 2,2′-bipyridinedicarboxylate, more preferably 2,2′-bipyridine-5,5′-dicarboxylate, a benzenetricarboxylate, preferably one or more of 1,2,3-benzenetricarboxylate, 1,2,4-benzenetricarboxylate, and 1,3,5-benzenetricarboxylate (BTC), benzenetetracarboxylate, adamantanetetracarboxylate (ATC), adamantanedibenzoate (ADB), benzenetribenzoate (BTB), methanetetrabenzoate (MTB), adamantanetetrabenzoate, and a dihydroxyterephthalate, preferably 2,5-dihydroxyterephthalate (DHBDC).

A preferred embodiment (70) concretizing any one of embodiments (57) to (69) relates to said process, wherein the one or more organic ligandsof the metal-organic framework comprise, preferably consist of, one or more of phthalate, isophthalate, terephthalate, 2,6-naphthalenedicarboxylate, 1,4-naphthalenedicarboxylate, 1,5-naphthalenedicarboxylate, 1,2,3-benzenetricarboxylate, 1,2,4-benzenetricarboxylate, 1,3,5-benzenetricarboxylate, and 1,2,4,5-benzenetetracarboxylate.

A preferred embodiment (71) concretizing any one of embodiments (57) to (70) relates to said process, wherein from 99 to 100 weight-%, preferably from 99.5 to 100, more preferably from 99.9 to 100 weight-%, of the metal-organic framework consists of the one or more metal ions M and the one or more organic ligands.

A preferred embodiment (72) concretizing any one of embodiments (57) to (71) relates to said process, wherein the metal-organic framework comprises M, C, O, and H.

A preferred embodiment (73) concretizing embodiment (72) relates to said process, wherein from 95 to 100 weight-%, preferably from 97 to 100 weight-%, more preferably from 99 to 100 weight-% of the metal-organic framework consists of M, C, O, and H, wherein more preferably from 95 to 100 weight-%, more preferably from 97 to 100 weight-%, more preferably from 99 to 100 weight-% of the metal-organic framework consists of M, C, O, and H.

A preferred embodiment (74) concretizing any one of embodiments (57) to (73) relates to said process, wherein the metal-organic framework is microporous, wherein the metal-organic framework preferably comprises one or more pores formed by one or more one-dimensional channels having a diameter in the range of from 5 to 15 Angstrom, preferably in the range of from 7 to 12 Angstrom.

A preferred embodiment (75) concretizing any one of embodiments (57) to (74) relates to said process, wherein the metal-organic framework shows an orthorhombic crystal system, preferably determined according to Reference Example 1.

A preferred embodiment (76) concretizing any one of embodiments (57) to (75) relates to said process, wherein the metal-organic framework shows an x-ray diffraction pattern comprising a peak having a maximum in the range of from 8° to 12° 2theta, preferably determined according to Reference Example 1.

A preferred embodiment (77) concretizing any one of embodiments (57) to (76) relates to said process, wherein the metal-organic framework shows an x-ray diffraction pattern comprising at least the following peaks:

| Intensity (%) | Diffraction angle 2θ/° [Cu K(alpha 1)] |
|---|---|
| 100 | 9.5-11.5 |
| 6-12 | 13-17 |
| 19-24 | 20-22 |
| 16-21 | 31-33 |
| 9-15 | 42-43.5 |

wherein 100% relates to the intensity of the maximum peak in the x-ray powder diffraction pattern, wherein the x-ray diffraction pattern is preferably determined according to Reference Example 1.

A preferred embodiment (78) concretizing any one of embodiments (57) to (77) relates to said process, wherein the metal-organic framework shows in the temperature programmed desorption of ammonia in the temperature range of from 100 to 500° C. an ammonia adsorption of equal to or smaller than 2.0 mmol/g, preferably of equal to or smaller than 1.9 mmol/g, more preferably in the range of from 0.1 to 1.8 mmol/g, more preferably in the range of from 0.5 to 1.7 mmol/g, more preferably in the range of from 1.0 to 1.6 mmol/g, preferably determined according to Reference Example 4.

A preferred embodiment (79) concretizing any one of embodiments (57) to (78) relates to said process, wherein the metal-organic framework shows in the temperature programmed desorption of ammonia in the temperature range of from 100 to 500° C. a first peak having a maximum in the range of from 100 to 300° C., preferably in the range of from 180 to 250° C., more preferably in the range of from 210 to 220° C., preferably determined according to Reference Example 4.

A preferred embodiment (80) concretizing any one of embodiments (57) to (79) relates to said process, wherein the metal-organic framework shows in the temperature programmed desorption of ammonia in the temperature range of from greater than 100 to 500° C. a second peak having a maximum in the range of from 225 to 400° C., preferably in the range of from 280 to 360° C., more preferably in the range of from 310 to 325° C., preferably determined according to Reference Example 4.

A preferred embodiment (81) concretizing any one of embodiments (57) to (80) relates to said process, wherein the mixture prepared in (i) comprises the metal-organic framework in an amount in the range of from 0.5 to 20.0 weight-%, more preferably in the range of from 0.75 to 10.0 weight-%, more preferably in the range of from 1.0 to 5.0 weight-%, more preferably in the range of from 1.25 to 3.5 weight-%, more preferably in the range of from 1.5 to 3.0 weight-%, more preferably in the range of from 1.7 to 2.5 weight-%, more preferably in the range of from 1.8 to 2.2 weight-%, based on the total weight of the mixture.

A preferred embodiment (82) concretizing any one of embodiments (57) to (81) relates to said process, wherein the metal-organic framework shows a water adsorption in the range of from 0.1 to 70 weight-% when exposed to a relative humidity of 85%, preferably in the range of from 0.25 to 60 weight-%, more preferably in the range of from 25.0 to 55.0 weight-%, more preferably in the range of from 35.0 to 52.0 weight-%, and more preferably in the range of from 45.0 to 50.0 weight-%, wherein the water adsorption is preferably determined according to Reference Example 3.

A preferred embodiment (83) concretizing any one of embodiments (57) to (82) relates to said process, wherein the metal-organic framework has a Langmuir specific surface area of at least 1000 m²/g, preferably of at least 1200 m²/g, more preferably in the range of from 1200 to 600 m²/g, preferably determined according to Reference Example 2.

A preferred embodiment (84) concretizing any one of embodiments (57) to (83) relates to said process, wherein the metal-organic framework shows in the temperature programmed desorption of water a type IV isotherm, preferably determined according to Reference Example 3.

A preferred embodiment (85) concretizing any one of embodiments (57) to (84) relates to said process, wherein the mixture prepared in (i) comprises the polyester in an amount in the range of from 30 to 99.0 weight-%, more preferably in the range of from 32.5 to 97.5 weight-%, more preferably in the range of from 32.5 to 95 weight-%, more preferably in the range of from 35 to 85 weight-%, based on the total weight of the mixture.

A preferred embodiment (86) concretizing any one of embodiments (57) to (85) relates to said process, wherein the polyester comprises a butanediol ester, preferably a monoester or a diester, more preferably a 1,4-butanediol ester.

A preferred embodiment (87) concretizing any one of embodiments (57) to (86) relates to said process, wherein the polyester comprises, preferably consists of, a poly(alkylene dicarboxylate) polyester, wherein the dicarboxylate of the poly(alkylene dicarboxylate) polyester comprises, preferably consists of, one or more of adipate, terephthalate, sebacate, azelate, succinate, and 2,5-furandicarboxylate, preferably one or more of adipate and terephthalate, more preferably adipate terephthalate or terephthalate, wherein the alkylene preferably comprises, more preferably consists of, one or more of ethylene, propylene, and butylene.

A preferred embodiment (88) concretizing any one of embodiments (57) to (87) relates to said process, wherein the polyester comprises one or more poly(alkylene) terephthalates, wherein the alkylene preferably comprises from 2 to 10, preferably from 3 to 5 carbon atoms, wherein the alkylene more preferably is butylene, wherein the polyester comprises more preferably one or more of a poly(ethylene) terephthalate, a poly(propylene) terephthalate, and a poly(butylene) terephthalate, wherein the polyester more preferably comprises, preferably consists of, one or more poly(butylene) terephthalates.

A preferred embodiment (89) concretizing embodiment (88) relates to said process, wherein the polyester comprises the poly(alkylene) terephthalate in an amount in the range of from 30 to 100 weight-%, preferably in the range of from 50 to 100 weight-%, more preferably in the range of from 60 to 100 weight-%, based on the total weight of the polyester.

A preferred embodiment (90) concretizing any one of embodiments (57) to (89) relates to said process, wherein the polyester has a viscosity number in the range of from 50 to 220, preferably in the range of from 80 to 160, preferably determined according to ISO 1628-5:1998.

A preferred embodiment (91) concretizing any one of embodiments (57) to (90) relates to said process, wherein the polyester has a melt-volume flow-rate in the range of from 10 to 160 cm³/g 600 s, preferably in the range of from 30 to 125 cm³/g 600 s, more preferably in the range of from 40 to 115 cm³/g 600 s, preferably determined according to ISO 1133 for 250° C./2.16 kg, wherein the polyester preferably comprises, preferably consists of, a poly(butylene) terephthalate.

A preferred embodiment (92) concretizing any one of embodiments (57) to (91) relates to said process, wherein the polyester comprises an amount of terminal carboxy groups equal to or less than 100 meq/kg of polyester, preferably equal to or less than 50 meq/kg of polyester, more preferably equal to or less than 40 meq/kg of polyester.

A preferred embodiment (93) concretizing any one of embodiments (57) to (92) relates to said process, wherein the polyester comprises Ti in an amount of equal to or less than 250 ppm, preferably equal to or less than 200 ppm, more preferably equal to or less than 150 ppm. A preferred embodiment (94) concretizing any one of embodiments (57) to (93) relates to said process, wherein the polyester comprises a blend of a poly(alkylene) terephthalate and a further polyester, wherein the further polyester is different to the poly(alkylene) terephthalate.

A preferred embodiment (95) concretizing any one of embodiments (57) to (94) relates to said process, wherein the polyester comprises a poly(alkylene) terephthalate and a fully aromatic polyester, preferably a fully aromatic polyester of an aromatic dicarboxylic acid or a fully aromatic polyester of an aromatic dihydroxy compound.

A preferred embodiment (96) concretizing embodiment (95) relates to said process, wherein the polyester comprises from 20 to 98 weight-% of the poly(alkylene) terephthalate and from 2 to 80 weight-% of the fully aromatic polyester.

A preferred embodiment (97) concretizing any one of embodiments (57) to (96) relates to said process, wherein the polyester comprises a polycarbonate, preferably a halide-free polycarbonate, more preferably a polycarbonate comprising a biphenol repeating unit.

A preferred embodiment (98) concretizing embodiment (97) relates to said process, wherein the polycarbonate comprises a relative viscosity nᵣₑₗ in the range of from 1.10 to 1.50, preferably in the range of from 1.25 to 1.40.

A preferred embodiment (99) concretizing embodiment (97) or (98) relates to said process, wherein the polycarbonate has an average molar mass M, (weight average molar mass) in the range of from 10000 to 200000 g/mol, preferably in the range of from 20000 to 80000 g/mol, preferably determined according to Reference Example 5.

A preferred embodiment (100) concretizing any one of embodiments (97) to (99) relates to said process, wherein the mixture prepared in (i) comprises an acrylic acid polymer, preferably in an amount in the range of from 0.01 to 2 weight-%, more preferably in the range of from 0.05 to 1.5 weight-%, more preferably in the range of from 0.1 to 1 weight-%, based on the total weight of the mixture prepared in (i).

A preferred embodiment (101) concretizing embodiment (100) relates to said process, wherein the acrylic acid polymer comprises acrylic acid units in an amount in the range of from 70 to 100 weight-%, preferably in the range of from 85 to 100 weight-%, based on the total weight of the acrylic acid polymer, and wherein the acrylic acid polymer preferably comprises an ethylenically unsaturated monomer different to acrylic acid, preferably selected from the group consisting of monoethylenically unsaturated carboxylic acids, preferably in an amount in the range of from equal to or greater than 0 to 30 weight-%, more preferably in the range of from equal to or greater than 0 to 15 weight-%, wherein the monoethylenically unsaturated carboxylic acid preferably comprises one or more of methacrylic acid, maleic acid, fumaric acid, itaconic acid, mesaconic acid, methylenemalonic acid, and citraconic acid.

A preferred embodiment (102) concretizing embodiment (100) or (101) relates to said process, wherein the acrylic acid polymer has an average molar mass M, (weight average molar mass) in the range of from 1000 to 100,000 g/mol, preferably in the range of from 1000 to 12,000 g/mol, more preferably in the range of from 1,500 to 8,000 g/mol, more preferably in the range of from 3,500 to 6,500 g/mol, preferably determined according to Reference Example 5.

A preferred embodiment (103) concretizing any one of embodiments (100) to (102) relates to said process, wherein the acrylic acid polymer has a pH of equal to or less than 4, preferably of equal to or less than 3.

A preferred embodiment (104) concretizing any one of embodiments (57) to (103) relates to said process, wherein the mixture prepared in (i) comprises one or more additives, wherein the additives are selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, preferably from the group consisting of glass fibers, minerals, impact-modifiers, fluorine-containing ethylene polymers, and a mixture of two or more thereof.

A preferred embodiment (105) concretizing embodiment (104) relates to said process, wherein the stabilizers comprise one or more of alkoxymethylmelamines, amino-substituted triazines, sterically hindered phenols, metal-containing compounds, alkaline earth metal silicates, alkaline earth metal glycerophosphates, polyamides, sterically hindered amines, wherein the metal-containing compounds preferably comprise one or more of potassium hydroxide, calcium hydroxide, magnesium hydroxide, and magnesium carbonate.

A preferred embodiment (106) concretizing embodiment (104) or (105) relates to said process, wherein the lubricants comprise an ester of a fatty acid and a polyol, wherein the fatty acid is preferably an unsaturated fatty acid or a saturated fatty acid, wherein the saturated fatty acid is preferably selected from the group consisting of caprylic acid, capric acid, lauric acid, stearic acid, arachidic acid, behenic acid, lignoceric acid, cerotic acid, and a mixture of two or more thereof, wherein the saturated fatty acid more preferably comprises, more preferably consists of, stearic acid, wherein the unsaturated fatty acid is preferably selected from the group consisting of myristoleic acid, palmitoleic acid, sapienic acid, oleic acid, elaidic acid, vaccenic acid, linoleic acid, linoelaidic acid, alpha-linolenic acid, arachidonic acid, eicosapentaenoic acid, erucic acid, docosahexaenoic acid, and a mixture of two or more thereof, wherein the polyol is preferably selected from the group of triols, tetrols, pentols, hexols, and ammixture of two or more thereof, wherein the polyol more preferably comprises one or more of sorbitol, xylitol, erythritol, threitol, and pentaerythritol, wherein the polyol more preferably comprises, more preferably consists of, pentaerythritol.

A preferred embodiment (107) concretizing any one of embodiments (104) to (106) relates to said process, wherein the mixture prepared in (i) comprises the lubricants in an amount in the range of from 0.20 to 1.00 weight-%, preferably in the range of from 0.35 to 0.70 weight-%, more preferably in the range of from 0.39 to 0.66 weight-%, based on the total weight of the mixture.

A preferred embodiment (108) concretizing any one of embodiments (104) to (107) relates to said process, wherein the glass fibers comprise one or more of glass wovens, glass mats, glass nonwovens, glass filament rovings, and chopped glass filaments made from low-alkali E glass, wherein the glass fibers preferably have a diameter in the range of from 5 to 200 micrometer, more preferably in the range of from 8 to 50 micrometer.

A preferred embodiment (109) concretizing any one of embodiments (104) to (108) relates to said process, wherein the impact-modifiers comprises one or more of an ethylene-propylene elastomer, an ethylene-propylene-diene elastomer, and an emulsion polymer.

A preferred embodiment (110) concretizing embodiment (109) relates to said process, wherein the elastomer is homogeneously structured and has a core-shell structure, wherein the core-shell structure preferably comprises a unit of one or more of 1,3-butadiene, isoprene, n-butyl acrylate, ethylhexyl acrylate, styrene acrylonitrile, and methyl methacrylate, for the core, and wherein the core-shell structure preferably comprises a unit of one or more of styrene acrylonitrile, methyl methacrylate, n-butyl acrylate, ethyl acrylate, methyl acrylate, 1,3-butadiene, isoprene, and ethylhexyl acrylate, for the shell.

A preferred embodiment (111) concretizing embodiment (109) or (110) relates to said process, wherein the emulsion polymer is selected from the group consisting of n-butyl acrylate(meth)acrylic acid copolymers, n-butyl acrylateglycidyl acrylate or n-butyl acrylate-glycidyl methacrylate copolymers.

A preferred embodiment (112) concretizing any one of embodiments (104) to (111) relates to said process, wherein the fillers comprise one or more of carbon black, glass fibers, glass beads, amorphous silica, asbestos, calcium silicate, calcium metasilicate, magnesium carbonate, kaolin, chalk, powdered quartz, mica, barium sulfate, feldspar, aramid fibers, potassium titanate fibers, and acicular mineral fillers, preferably acicular wollastonite.

A preferred embodiment (113) concretizing any one of embodiments (104) to (112) relates to said process, wherein the mixture prepared in (i) comprises a fluorine-containing ethylene polymer, preferably a fluorine-containing ethylene polymer comprising a fluorine content in the range of from 55 to 76 weight-%, more preferably in the range of from 70 to 76 weight-%, based on the total weight of the fluorine-containing ethylene polymer, wherein the fluorine-containing ethylene polymer preferably is one or more of polytetrafluoroethylene (PTFE), tetrafluoroethylene-hexafluoropropylene copolymers, and tetrafluoroethylene copolymers, wherein the mixture comprises the fluorine-containing ethylene polymer preferably in an amount in the range of from equal to or greater than 0 to 2 weight-%, based on the total weight of the mixture. A preferred embodiment (114) concretizing any one of embodiments (57) to (113) relates to said process, wherein the mixture prepared in (i) comprises the one or more additives in an amount in the range of from equal to or greater than 0 to 70 weight-%, based on the total weight of the mixture, preferably in the range of from 0.01 to 50 weight-%, more preferably in the range of from 0.1 to 30 weight-%, more preferably in the range of from 1 to 25 weight-%.

A preferred embodiment (115) concretizing any one of embodiments (57) to (114) relates to said process, wherein the metal-organic framework according to (i) is prepared according to a process comprising
(a) preparing a mixture comprising one or more sources of one or more metal ions M, one or more sources of one or more organic ligands, and optionally a solvent system;
(b) subjecting the mixture obtained from (a) in a gas atmosphere to reaction conditions;
(c) optionally isolating the metal-organic framework from the mixture obtained from (ii).

A preferred embodiment (116) concretizing embodiment (115) relates to said process, wherein M is selected from groups 2, 11, 12, 13 of the periodic system of elements, and combinations of two or more thereof, wherein M preferably is selected from the group consisting of Al, Ga, Cu, Ag, Zn, Mg, Mn, Ti, Fe, and combinations of two or more thereof, wherein M more preferably is one or more of Al and Zn, wherein M more preferably is Al.

A preferred embodiment (117) concretizing embodiment (115) or (116) relates to said process, wherein the one or more sources of one or more metal ions M are one or more of an alkoxide, an acetylacetonate, a halide, a sulfite, a salt of an organic acid and a salt of an inorganic acid.

A preferred embodiment (118) concretizing embodiment (117) relates to said process, wherein the alkoxide is one or more of methoxide, ethoxide, n-propoxide, i-propoxide, n-butoxide, t-butoxide, and phenolate.

A preferred embodiment (119) concretizing embodiment (117) or (118) relates to said process, wherein the halide is one or more of a chloride, a bromide, and an iodide.

A preferred embodiment (120) concretizing any one of embodiments (117) to (119) relates to said process, wherein the organic acid of the salt of the organic acid comprises oxygen, wherein the organic acid preferably is one or more of formic acid, acetic acid, propionic acid, and an alkyl monocarboxylic acid.

A preferred embodiment (121) concretizing any one of embodiments (117) to (120) relates to said process, wherein the inorganic acid of the salt of the inorganic acid comprises oxygen, wherein the inorganic acid preferably is one or more of sulfuric acid, sulfurous acid, phosphoric acid, and nitric acid.

A preferred embodiment (122) concretizing any one of embodiments (117) to (121) relates to said process, wherein M is Al, and wherein the one or more sources of Al ions are an aluminum containing salt, preferably one or more of aluminum chloride, aluminum bromide, aluminum hydrogensulfate, aluminum dihydrogenphosphate, aluminum monohydrogenphosphate, aluminum phosphate, aluminum nitrate, sodium aluminate, and potassium aluminate, wherein the one or more sources of Al ions more preferably are aluminum sulfate, more preferably aluminum sulfate octahydrate or aluminum sulfate tetrahydrate.

A preferred embodiment (123) concretizing any one of embodiments (117) to (122) relates to said process, wherein the one or more sources of one or more organic ligands comprise, preferably consist of, an organic compound or a salt of an organic compound, wherein the one or more sources of one or more organic ligands preferably comprise, preferably consist of, a salt of an organic compound, preferably one or more of a sodium salt, a potassium salt, and an ammonium salt.

A preferred embodiment (124) concretizing any one of embodiments (117) to (123) relates to said process, wherein the one or more sources of one or more organic ligands comprises one or more of a dicarboxylic acid, a tricarboxylic acid, and a tetracarboxylic acid.

A preferred embodiment (125) concretizing embodiment (124) relates to said process, wherein one or more of the dicarboxylic acid, the tricarboxylic acid, and the tetracarboxylic acid is substituted with one or more of —OH, —NH₂, —OCH₃, —CH₃, —NH(CH₃), —N(CH₃)₂, —CN, —SO₃H, and a halide.

A preferred embodiment (126) concretizing embodiment (124) or (125) relates to said process, wherein one or more of the dicarboxylic acid, the tricarboxylic acid, and the tetracarboxylic acid is present in the form of the sulfur analogue.

A preferred embodiment (127) concretizing any one of embodiments (124) to (126) relates to said process, wherein one or more of the dicarboxylic acid, the tricarboxylic acid, and the tetracarboxylic acid comprises a saturated aliphatic backbone, an unsaturated aliphatic backbone, an aromatic backbone, or a mixed aliphatic-aromatic backbone, wherein the aliphatic part of the backbone is saturated or unsaturated.

A preferred embodiment (128) concretizing embodiment (127) relates to said process, wherein the saturated aliphatic backbone, the unsaturated aliphatic backbone, or the aliphatic part of the backbone is linear, branched, or cyclic.

A preferred embodiment (129) concretizing embodiment (127) or (128) relates to said process, wherein the saturated aliphatic backbone, the unsaturated aliphatic backbone, or the aliphatic part of the backbone comprises from 1 to 18, preferably from 2 to 14, more preferably from 3 to 13, more preferably from 4 to 12, more preferably from 5 to 11, more preferably from 6 to 10, more preferably from 7 to 9, more preferably from 7 to 8 carbon atoms.

A preferred embodiment (130) concretizing any one of embodiments (127) to (129) relates to said process, wherein the saturated aliphatic backbone, the unsaturated aliphatic backbone, or the aliphatic part of the backbone comprises methane, adamantine, acetylene, ethylene, or butadiene.

A preferred embodiment (131) concretizing any one of embodiments (127) to (130) relates to said process, wherein the aromatic backbone or the aromatic part of the mixed aliphatic-aromatic backbone comprises one or more rings, preferably two, three, four or five rings, wherein one or more rings comprise one or more heteroatoms selected from the group consisting of N, O, S, B, P, Si, and combinations of two or more thereof, preferably selected from the group consisting of N, O, Si, and combinations of two or more thereof.

A preferred embodiment (132) concretizing any one of embodiments (127) to (131) relates to said process, wherein the aromatic backbone or the aromatic part of the mixed aliphatic-aromatic backbone comprises one or more of phenyl, naphthyl, biphenyl, bipyridyl, and pyridyl.

A preferred embodiment (133) concretizing any one of embodiments (115) to (132) relates to said process, wherein the one or more sources of one or more organic ligands comprises, preferably consists of, a dicarboxylic acid, preferably one or more of oxalic acid, succinic acid, tartaric acid, 1,4-butanedicarboxylic acid, 1,4-butenedicarboxylic acid, 4-oxopyran-2,6-dicarboxylic acid, 1,6-hexanedicarboxylic acid, decanedicarboxylic acid, 1,8-heptadecanedicarboxylic acid, 1,9-heptadecanedicarboxylic acid, heptadecanedicarboxylic acid, acetylenedicarboxylic acid, 1,2-benzenedicarboxylic acid, 1,3-benzenedicarboxylic acid, 2,3-pyridinedicarboxylic acid, pyridine-2,3-dicarboxylic acid, 1,3-butadiene-1,4-dicarboxylic acid, 1,4-benzenedicarboxylic acid, p-benzenedicarboxylic acid, imidazole-2,4-dicarboxylic acid, 2-methylquinoline-3,4-dicarboxylic acid, quinoline-2,4-dicarboxylic acid, quinoxaline-2,3-dicarboxylic acid, 6-chloroquinoxaline-2,3-dicarboxylic acid, 4,4′-diaminophenylmethane-3,3′-dicarboxylic acid, quinoline-3,4-dicarboxylic acid, 7-chloro-4-hydroxyquinoline-2,8-dicarboxylic acid, diimidedicarboxylic acid, pyridine-2,6-dicarboxylic acid, 2-methylimidazole-4,5-dicarboxylic acid, thiophene-3,4-dicarboxylic acid, 2-isopropylimidazole-4,5-dicarboxylic acid, tetrahydropyran-4,4-dicarboxylic acid, perylene-3,9-dicarboxylic acid, perylenedicarboxylic acid, Pluriol E 200-dicarboxylic acid, 3,6-dioxaoctanedicarboxylic acid, 3,5-cyclohexadiene-1,2-dicarboxylic acid, octanedicarboxylic acid, pentane-3,3-carboxylic acid, 4,4′-diamino-1,1′-biphenyl-3,3′-dicarboxylic acid, 4,4′-diaminobiphenyl-3,3′-dicarboxylic acid, benzidine-3,3′-dicarboxylic acid, 1,4-bis(phenylamino)benzene-2,5-dicarboxylic acid, 1,1′-binaphthyldicarboxylic acid, 7-chloro-8-methylquinoline-2,3-dicarboxylic acid, 1-anilinoanthraquinone-2,4′-dicarboxylic acid, polytetrahydrofuran 250-dicarboxylic acid, 1,4-bis(carboxymethyl)piperazine-2,3-dicarboxylic acid, 7-chloroquinoline-3,8-dicarboxylic acid, 1-(4-carboxy)phenyl-3-(4-chloro)phenylpyrazoline-4,5-dicarboxylic acid, 1,4,5,6,7,7-hexachloro-5-norbornene-2,3-dicarboxylic acid, phenylindanedicarboxylic acid, 1,3-dibenzyl-2-oxoimidazolidine-4,5-dicarboxylic acid, 1,4-cyclohexanedicarboxylic acid, naphthalene-1,8-dicarboxylic acid, 2-benzoylbenzene-1,3-dicarboxylic acid, 1,3-dibenzyl-2-oxoimidazolidine-4,5-cis-dicarboxylic acid, 2,2′-biquinoline-4,4′-dicarboxylic acid, pyridine-3,4-dicarboxylic acid, 3,6,9-trioxaundecanedicarboxylic acid, hydroxybenzophenonedicarboxylic acid, Pluriol E 300-dicarboxylic acid, Pluriol E 400-dicarboxylic acid, Pluriol E 600-dicarboxylic acid, pyrazole-3,4-dicarboxylic acid, 2,3-pyrazinedicarboxylic acid, 5,6-dimethyl-2,3-pyrazinedicarboxylic acid, bis(4-aminophenyl) ether diimide-dicarboxylic acid, 4,4′-diaminodiphenylmethane diimide-dicarboxylic acid, bis(4-aminophenyl) sulfone diimide-dicarboxylic acid, 1,4-naphthalenedicarboxylic acid, 2,6-naphthalenedicarboxylic acid, 1,3-adamantanedicarboxylic acid, 1,8-naphthalenedicarboxylic acid, 2,3-naphthalenedicarboxylic acid, 8-methoxy-2,3-naphthalenedicarboxylic acid, 8-nitro-2,3-naphthalenecarboxylic acid, 8-sulfo-2,3-naphthalenedicarboxylic acid, anthracene-2,3-dicarboxylic acid, 2′,3′-diphenyl-p-terphenyl-4,4″-dicarboxylic acid, (diphenyl ether)-4,4′-dicarboxylic acid, imidazole-4,5-dicarboxylic acid, 4(1H)-oxothiochromene-2,8-dicarboxylic acid, 5-tert-butyl-1,3-benzenedicarboxylic acid, 7,8-quinolinedicarboxylic acid, 4,5-imidazoledicarboxylic acid, 4-cyclohexene-1,2-dicarboxylic acid, hexatriacontanedicarboxylic acid, tetradecanedicarboxylic acid, 1,7-heptanedicarboxylic acid, 5-hydroxy-1,3-benzenedicarboxylic acid, 2,5-dihydroxy-1,4-benzenedicarboxylic acid, pyrazine-2,3-dicarboxylic acid, furan-2,5-dicarboxylic acid, 1-nonene-6,9-dicarboxylic acid, eicosenedicarboxylic acid, 4,4′-dihydroxy-diphenylmethane-3,3′-dicarboxylic acid, 1-amino-4-methyl-9,10-dioxo-9,10-dihydroanthracene-2,3-dicarboxylic acid, 2,5-pyridinedicarboxylic acid, cyclohexene-2,3-dicarboxylic acid, 2,9-dichlorofluorubin-4,11-dicarboxylic acid, 7-chloro-3-methylquinoline-6,8-dicarboxylic acid, 2,4-dichlorobenzophenone-2′,5′-dicarboxylic acid, 1,3-benzenedicarboxylic acid, 2,6-pyridinedicarboxylic acid, 1-methylpyrrol-3,4-dicarboxylic acid, 1-benzyl-1H-pyrrol-3,4-dicarboxylic acid, anthraquinone-1,5-dicarboxylic acid, 3,5-pyrazoledicarboxylic acid, 2-nitrobenzene-1,4-dicarboxylic acid, heptane-1,7-dicarboxylic acid, cyclobutane-1,1-dicarboxylic acid, 1,14-tetradecanedicarboxylic acid, 5,6-dehydronorbornane-2,3-dicarboxylic acid, 5-ethyl-2,3-pyridinedicarboxylic acid, and camphordicarboxylic acid.

A preferred embodiment (134) concretizing any one of embodiments (115) to (133) relates to said process, wherein the one or more sources of one or more organic ligands comprises, preferably consists of, a tricarboxylic acid, preferably one or more of 2-Hydroxy-1,2,3-propanetricarboxylic acid, 7-chloro-2,3,8-quinolinetricarboxylic acid, 1,2,3-benzenetricarboxylic acid, 1,2,4-benzenetricarboxylic acid, 1,2,4-butanetricarboxylic acid, 2-phosphono-1,2,4-butanetricarboxylic acid, 1,3,5-benzenetricarboxylic acid, 1-hydroxy-1,2,3-propanetricarboxylic acid, 4,5-dihydroxy-4,5-dioxo-1H-pyrrolo[2,3-f]quinoline-2,7,9-tricarboxylic acid, 5-acetyl-3-amino-6-methylbenzene-1,2,4-tricarboxylic acid, 3-amino-5-benzoyl-6-methylbenzene-1,2,4-tricarboxylic acid, 1,2,3-propanetricarboxylic acid, and aurintricarboxylic acid.

A preferred embodiment (135) concretizing any one of embodiments (115) to (134) relates to said process, wherein the one or more sources of one or more organic ligands comprises, preferably consists of, a tetracarboxylic acid, preferably one or more of 1,1-Dioxidoperylo[1,12-BCD]thiophene-3,4,9,10-tetracarboxylic acid, a perylenetetracarboxylic acid, preferably perylene-3,4,9,10-tetracarboxylic acid or (perylene-1,12-sulfone)-3,4,9,10-tetracarboxylic acid, a butanetetracarboxylic acid, preferably 1,2,3,4-butanetetracarboxylic acid or meso-1,2,3,4-butanetetracarboxylic acid, decane-2,4,6,8-tetracarboxylic acid, 1,4,7,10,13,16-hexaoxacyclooctadecane-2,3,11,12-tetracarboxylic acid, 1,2,4,5-benzenetetracarboxylic acid, 1,2,11,12-dodecanetetracarboxylic acid, 1,2,5,6-hexanetetracarboxylic acid, 1,2,7,8-octanetetracarboxylic acid, 1,4,5,8-naphthalenetetracarboxylic acid, 1,2,9,10-decanetetracarboxylic acid, benzophenonetetracarboxylic acid, 3,3′,4,4′-benzophenonetetracarboxylic acid, tetrahydrofurantetracarboxylic acid, and a cyclopentanetetracarboxylic acid, preferably cyclopentane-1,2,3,4-tetracarboxylic acid.

A preferred embodiment (136) concretizing any one of embodiments (115) to (135) relates to said process, wherein the one or more sources of one or more organic ligands comprises, preferably consists of, one or more of acetylenedicarboxylic acid (ADC), camphordicarboxylic acid, fumaric acid, succinic acid, a benzenedicarboxylic acid, an naphthalenedicarboxylic acid, a biphenyldicarboxylic acid, preferably 4,4′-biphenyldicarboxylic acid (BPDC), a pyrazinedicarboxylic acid, preferably 2,5-pyrazinedicarboxylic acid, a bipyridinedicarboxylic acid, preferably a 2,2′-bipyridinedicarboxylic acid, more preferably 2,2′-bipyridine-5,5′-dicarboxylic acid, a benzenetricarboxylic acid, preferably one or more of 1,2,3-benzenetricarboxylic acid, 1,2,4-benzenetricarboxylic acid, and 1,3,5-benzenetricarboxylic acid (BTC), benzenetetracarboxylic acid, adamantanetetracarboxylic acid (ATC), adamantanedibenzoate (ADB), benzenetribenzoate (BTB), methanetetrabenzoate (MTB), adamantanetetrabenzoate, and a dihydroxyterephthalic acid, preferably 2,5-dihydroxyterephthalic acid (DHBDC).

A preferred embodiment (137) concretizing any one of embodiments (115) to (136) relates to said process, wherein the one or more sources of one or more organic ligands comprises, preferably consists of, one or more of phthalic acid, isophthalic acid, terephthalic acid, 2,6-naphthalenedicarboxylic acid, 1,4-naphthalenedicarboxylic acid, 1,5-naphthalenedicarboxylic acid, 1,2,3-benzenetricarboxylic acid, 1,2,4-benzenetricarboxylic acid, 1,3,5-benzenetricarboxylic acid, and 1,2,4,5-benzenetetracarboxylic acid.

A preferred embodiment (138) concretizing any one of embodiments (115) to (137) relates to said process, wherein the solvent system comprises an organic compound or an inorganic compound.

A preferred embodiment (139) concretizing any one of embodiments (115) to (138) relates to said process, wherein the solvent system comprises water, preferably deionized water.

A preferred embodiment (140) concretizing any one of embodiments (115) to (139) relates to said process, wherein the solvent system comprises water in an amount of 50 to 100 weight-%, based on the total weight of the solvent system, preferably of 60 to 99 weight-%, more preferably of 70 to 95 weight-%, more preferably of 80 to 90 weight-%.

A preferred embodiment (141) concretizing any one of embodiments (115) to (140) relates to said process, wherein the solvent system comprises one or more of a C1-C6 alcohol, dimethyl sulfoxide (DMSO), N,N-dimethylformamide (DMF), N,N-diethylformamide (DEF), N,N-dimethylacetamide (DMAc), acetonitrile, toluene, 1,4-dioxane, benzene, chlorobenzene, butanone, pyridine, tetrahydrofuran (THF), ethyl acetate, an optionally halogenated C1-C200 alkane, sulfolane, diol, N-methyl-2-pyrrolidone (NMP), gamma-butyrolactone, an alicyclic alcohol, preferably cyclohexanol, a ketone, preferably acetone or acetylacetone, a cycloketone, preferably cyclohexanone, and sulfolene.

A preferred embodiment (142) concretizing embodiment (141) relates to said process, wherein the C1-C6 alcohol comprises one or more of methanol, ethanol, n-propanol, i-propanol, n-butanol, i-butanol, t-butanol, pentanol, hexanol.

A preferred embodiment (143) concretizing any one of embodiments (115) to (142) relates to said process, wherein a molar ratio of M of the one or more sources of one or more metal ions M, calculated as element, to the organic ligand of the one or more sources of one or more organic ligands, is in the range of from 0.3:1 to 1.7:1, preferably in the range of from 0.66:1 to 1.5:1, more preferably in the range of from 0.7:1 to 1.2:1, more preferably in the range of from 0.9:1 to 1.1:1.

A preferred embodiment (144) concretizing any one of embodiments (115) to (143) relates to said process, wherein the solvent system comprises an amount in the range of from 0 to 10 weight-% of water, preferably in the range of from 0.001 to 5 weight-%, more preferably in the range of from 0.01 to 1 weight-%, based on the total weight of the solvent system, wherein the solvent system more preferably is essentially free of water.

A preferred embodiment (145) concretizing any one of embodiments (115) to (144) relates to said process, wherein preparing the mixture in (a) comprises stirring.

A preferred embodiment (146) concretizing any one of embodiments (115) to (145) relates to said process, wherein the reaction conditions in (b) comprise solvothermal conditions.

A preferred embodiment (147) concretizing any one of embodiments (115) to (146) relates to said process, wherein the temperature of the gas atmosphere in (b) has a temperature in the range of from 20 to 200° C., preferably of from 100 to 170° C., more preferably of from 120 to 150° C.

A preferred embodiment (148) concretizing any one of embodiments (115) to (147) relates to said process, wherein the gas atmosphere in (b) comprises, preferably consists of, one or more of nitrogen, oxygen, argon, and air.

A preferred embodiment (149) concretizing any one of embodiments (115) to (148) relates to said process, wherein the reaction conditions comprise a pressure in the range of from 1 to 16 bar(abs), preferably in the range of from 1.1 to 3 bar(abs), more preferably in the range of from 1.150 to 1.230 bar.

A preferred embodiment (150) concretizing any one of embodiments (115) to (149) relates to said process, wherein the mixture prepared in (a) further comprises a base, preferably one or more of an alkali metal hydroxide, an amine, and an alkali metal carbonate, more preferably one or more of sodium hydroxide, potassium hydroxide, sodium carbonate sodium hydrogen carbonate.

A preferred embodiment (151) concretizing embodiment (150) relates to said process, wherein a molar ratio of organic compound to base is in the range of from 0.25 to 0.67, preferably in the range of from 0.25 to 0.5, more preferably in the range of from 0.3 to 0.4.

A preferred embodiment (152) concretizing any one of embodiments (115) to (151) relates to said process, wherein the process for preparing the metal-organic framework further comprises one or more of
(d) optionally washing the isolated metal-organic framework obtained from (b) or (c);
(e) optionally drying the isolated metal-organic framework obtained from (b), (c) or the washed metal-organic framework obtained from (d) in a gas atmosphere;
(f) calcining the isolated metal-organic framework obtained from (c), the dried metal-organic framework obtained from (d), or the washed metal-organic framework obtained from (e) in a gas atmosphere.

A preferred embodiment (153) concretizing embodiment (152) relates to said process, wherein washing in (d) is performed with one or more of a C1-C6 alcohol, dimethyl sulfoxide (DMSO), N,N-dimethylformamide (DMF), N,N-diethylformamide (DEF), N,N-dimethylacetamide (DMAc), acetonitrile, toluene, 1,4-dioxane, benzene, chlorobenzene, butanone, pyridine, tetrahydrofuran (THF), ethyl acetate, an optionally halogenated C1-C200 alkane, sulfolane, diol, N-methyl-2-pyrrolidone (NMP), gamma-butyrolactone, an alicyclic alcohol, preferably cyclohexanol, a ketone, preferably acetone or acetylacetone, a cycloketone, preferably cyclohexanone, and sulfolene.

A preferred embodiment (154) concretizing embodiment (152) or (153) relates to said process, wherein drying in (e) comprises spray-drying.

A preferred embodiment (155) concretizing any one of embodiments (152) to (154) relates to said process, wherein the gas atmosphere in (e) has a temperature in the range of from 50 to 150° C., preferably in the range of from 75 to 125° C.

A preferred embodiment (156) concretizing any one of embodiments (152) to (155) relates to said process, wherein the gas atmosphere in (e) comprises one or more of nitrogen and oxygen, wherein the gas atmosphere preferably is air or lean air.

A preferred embodiment (157) concretizing any one of embodiments (152) to (156) relates to said process, wherein the gas atmosphere in (f) has a temperature in the range of from 150 to 500° C., preferably in the range of from 250 to 450° C., more preferably in the range of from 300 to 400° C.

A preferred embodiment (158) concretizing any one of embodiments (152) to (157) relates to said process, wherein the gas atmosphere in (f) comprises one or more of nitrogen and oxygen, wherein the gas atmosphere preferably is air or lean air.

An embodiment (159) of the present invention relates to a molding comprising a polyester and a metal-organic framework, wherein the molding is obtainable and/or obtained by the process according to any one of embodiments (104) to (158).

An embodiment (160) of the present invention relates to a use of a molding according to any one of embodiments (1) to (103) and (159), as packaging, preferably as packaging for one or more of a food, a cosmetic, and a pharmaceutical, more preferably as packaging for one or more of skin cream, hair-care products, dental care products, medicaments, coffee, convenience food, meat, jam, a milk product, as a component for kitchen devices, preferably as a component being in contact with drinking water, or as a component for a car, preferably as a component for the interior of a motor-vehicle.

An embodiment (161) of the present invention relates to a use of a molding according to any one of embodiments (1) to (103) and (159), for the preparation of a fiber, a film, or a molding having a shape different from the molding according to any one of embodiments (1) to (103) and (159), preferably for the preparation of a capsule.

The present invention is further illustrated by the following examples and reference examples.

### EXAMPLES

### Reference Example 1: Determination of X-Ray Powder Diffraction

Powder X-ray diffraction (PXRD) data was collected using a diffractometer (Siemens D-5000 diffractometer or D8 Advance Series, Bruker). The samples were homogenized in a mortar and then pressed into a standard flat sample holder. The data was collected from the angular range 2 to 70° 2Theta with a step size of 0.02° 2Theta, the measuring time per step size was typically between 2 and 4 seconds. Cu-Kalpha radiation with variable primary and secondary covers and a secondary monochromator was used as the radiation source. The signal was detected using a scintillation (Siemens) or Solex semiconductor detector (Bruker). For data evaluation, reflections are distinguished from the background by an at least 3 times higher signal strength. An area analysis can be carried out manually by applying a baseline to the individual reflections. Alternatively, programs such as “Topas Profiles” from Bruker can be used, the background adaptation then preferably taking place automatically via a 1^{st} polynomial.

### Reference Example 2: Determination of the BET Specific Surface Area, the Langmuir Specific Surface Area, the Micropore Volume, the Average Pore Width and the Average Pore Diameter (N₂

The BET specific surface area, the Langmuir specific surface area, the micropore volume, the average pore width and the average pore diameter (N₂) were determined via nitrogen physisorption at 77 K according to the method disclosed in DIN 66131.

### Reference Example 3: Determination of Water Adsorption/Desorption Isotherm

Calculation of the water adsorption properties of the examples of the experimental section was performed on a VTI SA instrument from TA Instruments following a step-isotherm program. The experiment consisted of a run or a series of runs performed on a sample material that has been placed on the microbalance pan inside of the instrument. Before the measurement were started, the residual moisture of the sample was removed by heating the sample to 120° C. (heating ramp of 5° C./min) and holding it for 6 h under a N₂ flow. After the drying program, the temperature in the cell was decreased to 25° C. and kept isothermal during the measurements. The microbalance was calibrated, and the weight of the dried sample was balanced (maximum mass deviation 0.01 weight-%). Water uptake by the sample was measured as the increase in weight over that of the dry sample. First, an adsorption curve was measured by increasing the relative humidity (RH) (expressed as weight-% water in the atmosphere inside of the cell) to which the samples was exposed and measuring the water uptake by the sample at equilibrium. The RH was increased with a step of 10 weight-% from 5 to 85% and at each step the system controlled the RH and monitored the sample weight until reaching the equilibrium conditions and recording the weight uptake. The total adsorbed water amount by the sample was taken after the sample was exposed to the 85 weight-% RH. During the desorption measurement the RH was decreased from 85 weight-% to 5 weight-% with a step of 10% and the change in the weight of the samples (water uptake) was monitored and recorded.

### Reference Example 4: Temperature Programmed Desorption of Ammonia (NH₃-TPD

The temperature-programmed desorption of ammonia (NH₃-TPD) was conducted in an automated chemisorption analysis unit (Micromeritics AutoChem II 2920) having a thermal conductivity detector. Continuous analysis of the desorbed species was accomplished using an online mass spectrometer (OmniStar QMG200 from Pfeiffer Vacuum). The sample (0.1 g) was introduced into a quartz tube and analyzed using the program described below. The temperature was measured by means of a Ni/Cr/Ni thermocouple immediately above the sample in the quartz tube. For the analyses, He of purity 5.0 was used. Before any measurement, a blank sample was analyzed for calibration.
1. Preparation: Commencement of recording; one measurement per second. Wait for 10 minutes at 25° C. and a He flow rate of 30 cm³/min (room temperature (about 25° C.) and 1 atm); heat up to 600° C. at a heating rate of 20 K/min; hold for 10 minutes. Cool down under a He flow (30 cm³/min) to 100° C. at a cooling rate of 20 K/min (furnace ramp temperature); Cool down under a He flow (30 cm³/min) to 100° C. at a cooling rate of 3 K/min (sample ramp temperature).
2. Saturation with NH₃: Commencement of recording; one measurement per second. Change the gas flow to a mixture of 10% NH₃ in He (75 cm³/min; 100° C. and 1 atm) at 100° C.; hold for 30 minutes.
3. Removal of the excess: Commencement of recording; one measurement per second. Change the gas flow to a He flow of 75 cm³/min (100° C. and 1 atm) at 100° C.; hold for 60 min.
4. NH₃-TPD: Commencement of recording; one measurement per second. Heat up under a He flow (flow rate: 30 cm³/min) to 600° C. at a heating rate of 10 K/min; hold for 30 minutes.
5. End of measurement.

Desorbed ammonia was measured by means of the online mass spectrometer, which demonstrates that the signal from the thermal conductivity detector was caused by desorbed ammonia. This involved utilizing the m/z=16 signal from ammonia in order to monitor the desorption of the ammonia. The amount of ammonia adsorbed (mmol/g of sample) was ascertained by means of the Micromeritics software through integration of the TPD signal with a horizontal baseline.

### Reference Example 5: Determination of the Molecular Weight of a Polymer

Molar masses of employed polyesters and polymers were determined by means of GPC. The GPC conditions used were as follows: 2 columns (Suprema Linear M) and one pre-column (Suprema pre-column), all using Suprema Gel (HEMA) products from Polymer Standard Services (Mainz, Germany), were operated at 35° C. with flow rate 0.8 ml/min. Eluent used comprised the aqueous solution buffered at pH 7 by TRIS, admixed with 0.15M NaCl and 0.01M NaN₃. Calibration was achieved with a Na-PAA standard of which the cumulative molar mass distribution curve had been determined by combined SEC/laser light scattering, by the calibration method of M. J. R. Cantow et al. (J. Polym. Sci., A-1.5 (1967) 1391-1394), but without the concentration correction proposed in that reference. All of the specimens were adjusted to pH 7 with 50% by weight aqueous sodium hydroxide solution. A portion of the solution was diluted with deionized water to 1.5 mg/ml solids content and stirred for 12 hours. The specimens were then filtered, and 100 μl were injected through a Sartorius Minisart RC (0.2 μm).

### Reference Example 6: Preparation of a Metal-Organic Framework

A metal-organic framework was prepared in accordance with Example 1 of WO 2012/042410 A1.

### Examples 1-2, and Comparative Examples 3-8: Preparation of a Molding Comprising a Polyester and an Metal-Organic Framework

As starting materials, a poly(butylene) terephthalate (PBT, Ultradur® B1950 NAT. of BASF company) with a melt-volume flow-rate (MVR) of 110 cm³/g 10 min. (in accordance with ISO 1133 for 250° C./2.16 kg), and a poly(butylene) terephthalate (PBT, B2550 NAT. of BASF company) with a melt-volume flow-rate (MVR) of 45 cm³/g 10 min. (in accordance with ISO 1133 for 250° C./2.16 kg) were used.

Further, a polyacrylic acid with average molar mass (M_{w}) of 5000 g/mol (by GPC) in the form of 49% aqueous solution (Sokalan® PA 25 XS from BASF SE) having a pH of 2, and glass fibers (glass fibers suitable for PBT; of 3B company) were used. As a lubricant, a mixture of C16-C18 fatty acid esters of pentaerythritol was used.

As metal-organic framework, a metal-organic framework according to Reference Example 6, was used for Examples 1 and 2 in accordance with the present invention.

In addition, further moldings were prepared for comparative reasons. For Comparative Examples 3-8, three different zeolite Y (having a SAR of 80, 30, 60; CBV780, CBV720, and CBV760, respectively; all purchased from Zeolyst), an ammonium zeolite Y (CBV712 from Zeolyst having a SAR of 12), a sodium zeolite Y (CBV100 from Zeolyst having a SAR of 5.1) and a sodium A zeolite (molecular sieve 13X having a SAR of 2.5; Alfa Aesar company; in accordance with U.S. Pat. No. 4,061,662) were used. An overview of the characteristics of the used materials can be found in table 1.

TABLE 1
Overview of characteristics of materials used
in the examples and comparative examples.

| | Metal-organic | SAR | | NH₃-TPD |
|---|---|---|---|---|
| | framework | where ap- | Water uptake | (Tₘₐₓ in ° C.; |
| # | or Molecular sieve | plicable | (weight-%) | mmol/g) |
| Example(s) | | | | |
| 1, 2 | Al fumarate | — | 48.1 | 214; 0.250 |
| | (Basolite A520) | | | 318; 1.319 |
| Comparative | | | | |
| Example | | | | |
| 3 | Y (H-form) | 80 | 34.6 | 167; 0.038 |
| | | | | 330; 0.136 |
| | | | | 566; 0.111 |
| 4 | Y (H-form) | 30 | 33.3 | 191; 0.183 |
| | | | | 347; 0.447 |
| | | | | 528; 0.090 |
| 5 | Y (H-form) | 60 | 34.8 | 174; 0.070 |
| | | | | 347; 0.202 |
| | | | | 535; 0.098 |
| 6 | NH₄Y | 12 | 30.9 | 198; 0.384 |
| | | | | 354; 0.608 |
| 7 | NaY | 5.1 | 28.9 | 207; 0.855 |
| 8 | NaA | 2.5 | 28.7 | 192; 0.841 |
| | | | | 272; 1.379 |

A metal-organic framework or a zeolite was used, such that the resulting molding comprised 1 or 2 weight-% of the metal-organic framework or of the zeolite based on the total weight of the molding.

Thus, Examples in accordance with the present invention were prepared as well as Comparative Examples using the starting materials and amounts thereof as noted in table . . . .

TABLE 2
Overview of amounts of starting materials used for Comparative examples
3-8 and Examples 1-2 in accordance with the present invention.

| | | | Comp. | Comp. | Comp. | Comp. | Comp. | Comp. |
|---|---|---|---|---|---|---|---|---|
| | Ex. 1 | Ex. 2 | Ex. 3 | Ex. 4 | Ex. 5 | Ex. 6 | Ex. 7 | Ex. 8 |
| Poly(butylene) | 97.8 | 96.8 | 97.8 | 97.8 | 97.8 | 97.8 | 97.8 | 97.8 |
| terephthalate (Ultradur | | | | | | | | |
| B1950 NAT.) | | | | | | | | |
| Lubricant (C16-C18 | 0.65 | 0.65 | 0.65 | 0.65 | 0.65 | 0.65 | 0.65 | 0.65 |
| fatty acid esters of | | | | | | | | |
| pentaerythritol) | | | | | | | | |
| Polyacrylic acid | 0.55 | 0.55 | 0.55 | 0.55 | 0.55 | 0.55 | 0.55 | 0.55 |
| MOF (Basolite A520) | 1 | 2 | — | — | — | — | — | — |
| CBV780 | — | — | 1 | — | — | — | — | — |
| CBV720 | — | — | — | 1 | — | — | — | — |
| CBV760 | — | — | — | — | 1 | — | — | — |
| CBV712 | — | — | — | — | — | 1 | — | — |
| CBV100 | — | — | — | — | — | — | 1 | — |
| Molecular sieve 13× | — | — | — | — | — | — | — | 1 |

For Comparative Examples 3-8 and Examples 1-2 in accordance with the present invention (see tables 1 and 2), the poly(butylene terephthalate) (water content below 0.04 weight-%), the polyacrylic acid and the lubricant were extruded together with the metal-organic framework in a twin-screw extruder at melt temperature of 240° C. on a DSM mini-extruder. The poly(butylene terephthalate) and the metal-organic framework were weighted in and dried overnight at 80° C.

The resulting dry mixture was filled into a pre-heated DSM mini-extruder and the polyacrylic acid solution was added. The mixture was compounded for 3 minutes and after this time the melt was released and granulated.

### Example 9: Determination of the VOC Outgassing

Emission analysis was carried out in accordance with VDA 277, a standard method of the Automobile Industry Association for the determination of TOC (=total organic carbon emission). VDA 277 is used to investigate the carbon emission of nonmetallic materials used in motor vehicles.

All Examples 1-2 in accordance with the present invention and Comparative examples 3-8 were tested with regard to their VOC outgassing in accordance with test procedure VDA 277 (German: “Prüfvorschrift VDA 277”; being equivalent to VW-Norm PV3341 of Volkswagen company).

In accordance with VDA 277, the following conditions were applied. Each testing was performed three times and the results were averaged. For one testing, 2 g of a sample comprising a granulate having a weight in the range of from 10 to 25 mg were placed in a sealable cylindrical flask (German: “Head-Space-Glsschen”). The flask was sealed such that it comprised a sample phase and a so-called head-space phase. Then, the granulate was heated to a temperature of 120° C. for 5 h allowing outgassing of the granulate into the head-space phase. After heating, the gas phase was immediately analyzed by gas chromatography and the outgassing determined. The results are shown in table 3 below.

TABLE 3
Outgassing from Comparative Examples 3-8 and Examples 1-2 in
accordance with the present invention.

| | | | Outgassing | |
|---|---|---|---|---|
| | Metal-organic | | TOC* | THE content |
| | framework | | [ppm] | [ppm] |
| | or zeo- | Content in | (averaged for | (averaged for |
| # | lite | weight-% | 3 samples) | 3 samples) |
| Example | | | | |
| 1 | Al fumarate | 1 | 7 | 6 |
| | (Baso-lite A520) | | | |
| 2 | Al fumarate | 2 | 6 | 5 |
| | (Baso-lite A520) | | | |
| Comparative | | | | |
| Example | | | | |
| 3 | HY | 1 | 396 | 321 |
| 4 | HY | 1 | 631 | 500 |
| 5 | HY | 1 | 603 | 468 |
| 6 | NH₄Y | 1 | 490 | 443 |
| 7 | NaY | 1 | 127 | 124 |
| 8 | NaA | 1 | 149 | 141 |

(*)determined according to VDA 277

As can be seen from the results for the determination of VOC outgassing, the moldings of Examples 1 and 2 show exceptionally lower emissions as regards outgassing determined according to VDA 277. Similarly, the TH F emissions were shown to be comparatively lower for the Examples in accordance with the present invention.

### CITED LITERATURE

EP 3004242 B1
JP 2019 014826 A
WO 2012/042410 A1
WO 2007/118841 A2

1. A molding comprising,
(i) a polyester in an amount in a range of from 25 to 99.99 weight-%, based on the total weight of the molding,
(ii) a metal-organic framework in an amount of from 0.01 to 25 weight-%, based on the total weight of the molding,
wherein the metal-organic framework comprises one or more metal ion M and one or more organic ligand.

2. The molding of claim 1, wherein the one or more metal ion M is selected from groups 2, 11, 12, and 13 of the periodic system of elements, and combinations of two or more thereof.

3. The molding of claim 1, wherein the metal-organic framework comprises the one or more metal ion M in an amount in the range of from 10 to 25 weight-%, based on the total weight of the metal-organic framework.

4. The molding of claim 1, wherein the one or more organic ligand is an anion.

5. The molding of claim 1, wherein the metal-organic framework comprises M, C, O, and H.

6. The molding of claim 1, wherein the metal-organic framework has in a temperature programmed desorption of ammonia in a temperature range of from 100 to 500° C. an ammonia adsorption of equal to or smaller than 2.0 mmol/g, wherein the temperature programmed desorption of ammonia is determined according to Reference Example 4.

7. The molding of claim 1, wherein the metal-organic framework has a water adsorption in a range of from 0.1 to 70 weight-% when exposed to a relative humidity of 85%, wherein the water adsorption is determined according to Reference Example 3.

8. The molding of claim 1, wherein the polyester comprises a butanediol ester.

9. The molding of claim 1, wherein the polyester comprises a poly(alkylene dicarboxylate) polyester.

10. The molding of claim 1, comprising an acrylic acid polymer, based on the total weight of the molding.

11. The molding of claim 1, wherein the molding further comprises one or more additives.

12. A process for preparing a molding comprising a polyester and a metal-organic framework, comprising
preparing a mixture comprising a polyester in an amount in a range of from greater than 25 to 99.99 weight-%, based on the total weight of the mixture, a metal-organic framework in an amount of from 0.01 to 25 weight-%, based on the total weight of the mixture, and optionally one or more additives in an amount in the range of from equal to or greater than 0 to 70 weight-%, based on the total weight of the mixture;
shaping the mixture obtained from (i);
wherein the metal-organic framework comprises one or more metal ion M and one or more organic ligand.

13. The process of claim 12, wherein the metal-organic framework according to (i) is prepared according to a process comprising
(a) preparing a mixture comprising one or more sources of one or more metal ion M, one or more sources of one or more organic ligand, and optionally a solvent system;
(b) subjecting the mixture obtained from (a) in a gas atmosphere to reaction conditions;
(c) optionally isolating the metal-organic framework from the mixture obtained from (ii).

14. A molding comprising a polyester and a metal-organic framework, wherein the molding is obtained by the process according to claim 12.

15. (canceled)

16. The molding according to claim 14 wherein the molding is a package, fiber, film, or capsule.
